(19) United States
(12) Patent Application Publication
(10) Pub. No.: US 2010/0016507 A1
(43) Pub. Date: Jan. 21, 2010

(54) THERMOPLASTIC RESIN, PROCESS FOR PRODUCTION OF THE SAME, AND MOLDED ARTICLE MANUFACTURED FROM THE SAME

(75) Inventors: Norifumi Sumimoto, Tokyo (JP); Wataru Kakuno, Tokyo (JP); Tetsuya Kubota, Tokyo (JP); Atsushi Watanabe, Tokyo (JP); Toshio Oohama, Ibaraki (JP); Takeshi Watanabe, Ibaraki (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Techno Polymer Co., Ltd., Chuo-ku (JP)

(21) Appl. No.: 11/916,065

(22) PCT Filed: Jun. 1, 2006
(86) PCT No.: PCT/JP2006/311024

§ 371 Date: Nov. 30, 2007

(30) Foreign Application Priority Data
Jun. 3, 2005 (JP) 2005-164608
Mar. 29, 2006 (JP) 2006-091828
Apr. 5, 2006 (JP) 2006-104703

(51) Int. Cl. C08L 51/04

(52) U.S. Cl. 525/70

(57) ABSTRACT

The objective of the present invention is to provide a thermoplastic resin capable of producing a thin-walled article such as a film, a sheet and a bag stably by extrusion such as calender molding, and of leading to a thin-walled article wherein an undesirable phenomenon due to flow marks generated on the surface is improved and which is excellent in whitening resistance upon bending, and the like, and a method for the production thereof, a molded article and a composite article comprising thereof. The present thermoplastic resin comprises an acryl-based rubbery polymer reinforced resin having a graft ratio of 80% to 170%, a number-average particle diameter of an acryl-based rubbery polymer of 60 to 150 nm, an intrinsic viscosity of a component dissolved by acetonitrile of 0.4 to 0.8 dl/g, a content of a bound cyanidated vinyl compound in the component dissolved by acetonitrile of 20% to 30% by mass, and standard deviation of a distribution of the content of a bound cyanidated vinyl compound measured using liquid chromatography is 5 or less.

### TECHNICAL FIELD

The present invention relates to a thermoplastic resin and a method for the production thereof and a molded article. More particularly, the present invention relates to a thermoplastic resin capable of producing a thin-walled article such as a film, a sheet and a bag stably by extrusion such as calender molding, and of leading to a thin-walled article wherein an undesirable phenomenon due to flow marks generated on the surface is improved and which is excellent in whitening resistance upon bending, and the like, and a method for the production thereof, a molded article and a composite article comprising thereof.

### BACKGROUND ART

In recent years, calender molding, T-die molding, blown film extrusion and the like have been applied in order to efficiently produce small amounts of a variety of different thin-walled articles such as films with high thickness precision. Calendar molding is a method in which a resin as a raw material is fed in a molten or semi-molten state into a series of hot rolls and rolled into a film, and generally comprises steps for kneading a resin, calender processing (film formation), cooling and winding.

Conventionally, a vinyl chloride-based resin has been used as a molding material for calender molding in order to produce adhesive films, bases for a decorative material and the like. However, issues relating to the environment have prompted investigations regarding recyclable alternatives, e.g., an olefin-based resin such as polyethylene and polypropylene, a rubber-reinforced resin such as an ABS resin and an AES resin, and the like.

Additionally, a resin composition for T-die molding is disclosed in JP-A 2003-103598, which comprises an olefin-based copolymer and a hydrocarbon-based oil. JP-A 2003-253016 discloses a film where an acrylic resin comprising an acryl-based rubber particle is subjected to T-die molding. Further, JP-A 2002-3620 discloses a film where a composition comprising a copolymer of primarily a methacrylic acid alkyl ester and a copolymer obtained by graft copolymerization of a methacrylic acid alkyl ester in the presence of an elastic polymer of a methacrylic acid alkyl ester is subjected to T-die molding.

Moreover, a resin composition for blown film extrusion is disclosed in JP-A 2003-147140, which is a styrene-based resin composition. Further, JP-A H11-268117 discloses a blown film comprising a styrene-based polymer having a syndiotactic structure primarily.

### DISCLOSURE OF THE INVENTION

### Problems to be Solved by the Invention

A thin-walled article such as a film is obtained by machining a variety of resins and compositions according to the intended use or the like. However, when conventional resins are subjected to calender molding, the preliminary kneading (kneading using rolls or the like) of resins fed to a calender roll is not smoothly performed, the supply of a kneaded material becomes unstable, the state of a bank between the calender rolls becomes unstable, and other factors related to workability are adversely affected. As a result, the thickness of the resulting thin-walled article may be irregular, streaking may occur on the surface, breakage may occur during retrieval, whitening may occur upon bending, and other defects may be more likely to occur. Additionally, in the case where films and the like are molded using T-die, the molten resin is not smoothly discharged from the T-die, whereby the lip of the die is more readily soiled, thickness precision deteriorates, and labor is required to address operating performance. Further, in the case of blown film extrusion, the molten resin is not smoothly discharged from the die, whereby the lip of the die is more readily soiled, and a blown film bubble is more likely to wobble. Thickness precision therefore deteriorates, and workability is inadequate. Moreover, die streaks and other defects may be more likely to occur on the surface of the resulting film, bag and the like. Accordingly, a resin composition suitable for extrusion molding such as calender molding has been needed.

It is an objective of the present invention to provide a thermoplastic resin capable of producing a thin-walled article such as a film stably, and of leading to a thin-walled article wherein an undesirable phenomenon due to flow marks generated on the surface is improved and which is excellent in whitening resistance (that is a performance where whitening is hard to occur or does not occur) upon bending for calender molding; capable of producing a thin-walled article such as a film stably (thickness precision is high, the lip of the die is not readily soiled, little labor is required for stable operation, and the like), and of leading to a thin-walled article wherein an undesirable phenomenon generated on the surface of the thin-walled article is improved and which is excellent in whitening resistance (that is a performance where whitening is hard to occur or does not occur) upon bending for T-die molding; and capable of producing a thin-walled article such as a film and a bag stably (thickness precision is high, the lip of the die is not readily soiled, the wobble of the blown film bubble is hard to occur, and the like), and of leading to a thin-walled article wherein an undesirable phenomenon (die streaks and the like) generated on the surface during producing is improved and which is excellent in whitening resistance upon bending for blown film extrusion, and a method for the production thereof, a molded article and a composite article comprising thereof.

### Means for Solving Problems

The present inventors studied diligently to find that a thermoplastic resin comprising a specific acryl-based rubber-reinforced resin solved the above-mentioned problems and complete the present invention.

The thermoplastic resin of the present invention is characterized by comprising an acryl-based rubbery polymer reinforced resin having a graft ratio of 80% to 170%, a number-average particle diameter of an acryl-based rubbery polymer of 60 to 150 nm, an intrinsic viscosity of a component dissolved by acetonitrile of 0.4 to 0.8 dl/g, a content of a bound cyanidated vinyl compound in the component dissolved by acetonitrile of 20% to 30% by mass, and standard deviation of a distribution of the content of a bound cyanidated vinyl compound measured using liquid chromatography is 5 or less.

The above-mentioned acryl-based rubbery polymer reinforced resin preferably comprises a graft copolymeric resin that is obtained by polymerizing a vinyl-based monomer containing an aromatic vinyl compound and a cyanidated vinyl compound in the presence of an acryl-based rubbery polymer.

The above-mentioned acryl-based rubbery polymer reinforced resin is preferably one wherein a copolymer comprising a unit derived from an aromatic vinyl compound and a unit derived from a cyanidated vinyl compound is further incorporated.

The production method for the thermoplastic resin of the present invention is characterized in comprising a polymerizing step for polymerization of a vinyl-based monomer containing an aromatic vinyl compound and a cyanidated vinyl compound while the vinyl-based monomer is added in the presence of an acryl-based rubbery polymer having a volume-average particle diameter of 60 to 150 nm, wherein a ratio of a total amount of the aromatic vinyl compound and the cyanidated vinyl compound is in the range from 70% to 100% by mass in the vinyl-based monomer, wherein amounts to be used of the aromatic vinyl compound and the vinyl cyanide compound are respectively from 70% to 80% by mass and from 20% to 30% by mass with respect to 100% by mass of the total of these compounds, and wherein the polymerization is performed while polymerization conversion of the vinyl-based monomer in the reaction system is kept at 85% or more by mass.

In addition, the molded article of the present invention is a molded article that is obtained using the above-mentioned thermoplastic resin of the present invention and is suitable for a thin-walled article such as a sheet and a film.

Moreover, the composite article of the present invention is characterized in having a molded part comprising the above-mentioned thermoplastic resin of the present invention, and a portion comprising at least one material selected from the group consisting of an organic material and an inorganic material, disposed on at least one part of a surface of the molded part.

### EFFECTS OF THE INVENTION

According to the thermoplastic resin of the present invention, a thin-walled article such as a film can be produced stably by calender molding; and a thin-walled article wherein an undesirable phenomenon due to flow marks generated on the surface is improved and which is excellent in whitening resistance upon bending can be obtained. When T-die molding is performed, a thin-walled article such as a film can be stably produced and a thin-walled article wherein an undesirable phenomenon generated on the surface is improved and which is excellent in whitening resistance upon bending can be obtained. Additionally, when blown film extrusion is performed, a thin-walled article such as a film and a bag, wherein an undesirable phenomenon generated on the surface is improved can be stably produced.

Since whitening resistance is excellent in the case of bending the thin-walled article, appearance is never deteriorated and a higher designability can be maintained when it is formed into a specific shape. It is therefore widely used for a tacky film, sheet, label and the like, and is suitable for a tacky label, a tacky film for a substitute for a decorative paper and the like.

The composite article of the present invention comprises a molded part comprising the above-mentioned thermoplastic resin of the present invention, and a portion comprising at least one material selected from the group consisting of an organic material and an inorganic material, disposed on at least one part of a surface of this molded part, generation of whitening and wrinkling on the molded part are suppressed and appearance is excellent.

### BRIEF DESCRIPTION OF THE DRAWINGS

FIG. 1 is a schematic diagram that shows an example of an apparatus for the production of a thin-walled article.

FIG. 2 is a schematic diagram that shows another example of an apparatus for the production of a thin-walled article.

FIG. 3 is a schematic diagram that shows another example of an apparatus for the production of a thin-walled article.

FIG. 4 is a cross-sectional diagram that shows an example of an adhesive film as a composite article.

FIG. 5 is a cross-sectional diagram that shows an example of a layered sheet as a composite article.

FIG. 6 is a cross-sectional diagram that shows another example of a layered sheet as a composite article.

### DESCRIPTION OF REFERENCE NUMERALS AND SIGNS

1: Thin-walled article
1a: Soft thin-walled extrudate (soft film)
2: T-die
31, 31a and 31b: Cast roll
32-34: Carrier roll
4: Winder roll
5: Composite article (tacky film)
51: Thin-walled article (molded part [X])
52: Anchor-coat layer
53: Tacky layer (portion [Y])
6: Composite article (layered sheet)
61: Thin-walled article (molded part [X])
62, 62a and 62b: Resin layer (portion [Y])

### BEST MODE FOR CARRYING OUT THE INVENTION

The invention is described in further detail.

In this specification, “(co)polymer(ize)” means homopolymer(ize) and copolymer(ize), “(meth)acryl” means acryl and methacryl, and “(meth)acrylate” means acrylate and methacrylate.

### 1. Thermoplastic Resin

The thermoplastic resin of the present invention is a resin consisting of only a polymer component comprising an acryl-based rubbery polymer reinforced resin having a graft ratio of 80% to 170%, a number-average particle diameter of an acryl-based rubbery polymer of 60 to 150 nm, an intrinsic viscosity of a component dissolved by acetonitrile of 0.4 to 0.8 dl/g, a content of a bound cyanidated vinyl compound in the component dissolved by acetonitrile of 20% to 30% by mass, and standard deviation of a distribution of the content of a bound cyanidated vinyl compound measured using liquid chromatography is 5 or less. The thermoplastic resin of the present invention may contain other polymer components as necessary.

The above-mentioned acryl-based rubbery polymer reinforced resin is a graft copolymeric resin (hereinafter, referred to as “rubber-reinforced vinyl-based resin (A1)”) obtained by polymerizing a vinyl-based monomer (hereinafter, referred to as “vinyl-based monomer (a2)”) containing an aromatic vinyl compound and a vinyl cyanide compound, in the presence of an acryl-based rubbery polymer (hereinafter, referred to as “acryl-based rubbery polymer (a1)”) or a mixture (hereinafter, referred to as “mixture (A3)”) of the rubber-reinforced vinyl-based resin (A1) and a separately compounded (co)polymer (hereinafter, referred to as “(co)polymer (A2)”) of a vinyl-based monomer. The above-mentioned rubber-reinforced vinyl-based resin (A1) usually contains a grafted acryl-based rubbery polymer wherein one of a (co)polymer of the vinyl-based monomer (a2) is grafted to a surface of the acryl-based rubbery polymer (a1), and a (co)polymer of the vinyl-based monomer (a2), namely, a non-grafted component wherein a residual copolymer comprising a unit derived from an aromatic vinyl compound and a unit derived from a cyanidated vinyl compound is not grafted, and contains sometimes an acryl-based rubbery polymer (a1) on which a (co)polymer of the vinyl-based monomer (a2) is not grafted.

The above-mentioned acryl-based rubbery polymer (a1) is a polymer obtained using a monomer containing a (meth)acrylic acid alkyl ester and is preferably a (co)polymer of a (meth)acrylic acid alkyl ester (m1) having carbon atoms of an alkyl group in the range from 1 to 12. The further preferable is a copolymer obtained using a monomer containing the (meth)acrylic acid alkyl ester (m1) and a multi-functional vinyl compound (m2). In addition, a copolymer obtained using a (meth)acrylic acid alkyl ester, a multifunctional vinyl compound and other compound (m3) which is capable of copolymering with these compounds may be used.

Examples the above-mentioned (meth)acrylic acid alkyl ester (m1) having carbon atoms of an alkyl group in the range from 1 to 12 include methyl (meth)acrylate, ethyl (meth)acrylate, n-propyl (meth)acrylate, isopropyl (meth)acrylate, n-butyl (meth)acrylate, isobutyl (meth)acrylate, amyl (meth)acrylate, n-hexyl (meth)acrylate, n-octyl (meth)acrylate, 2-ethylhexyl (meth)acrylate, dodecyl (meth)acrylate, cyclohexyl (meth)acrylate, phenyl (meth)acrylate, benzyl (meth)acrylate and the like. The (meth)acrylic acid alkyl ester (m1) may be used alone or in combination of two or more types thereof, however, it is selected so that grass transition temperature of the resultant (co)polymer is 0° C. or lower and preferably −10° C. or lower. Among these compounds, n-butyl acrylate and 2-ethylhexyl acrylate are preferred.

The above-mentioned “multi-functional vinyl compound” is a compound having two or more polymerizable unsaturated bonds in its molecule. Examples of the above-mentioned multi-functional vinyl compound (m2) include a bifunctional aromatic vinyl compound such as divinyl benzene and divinyl toluene; a bifunctional (meth)acrylic acid ester such as 1,6-hexanediol diacrylate, 1,6-hexanediol dimethacrylate, ethyleneglycol diacrylate, ethyleneglycol dimethacrylate, neopentylglycol diacrylate, allyl acrylate, neopentylglycol dimethacrylate, triethyleneglycol diacrylate, triethyleneglycol dimethacrylate, 3-methylpentanediol diacrylate, 3-methylpentanediol dimethacrylate and allyl methacrylate; a trifunctional (meth)acrylic acid ester such as trimethylolpropane triacrylate, trimethylolpropane trimethacrylate, pentaerythritol triacrylate, pentaerythritol trimethacrylate, pentaerythritol tetraacrylate, pentaerythritol tetramethacrylate, pentaerythritol pentaacrylate, pentaerythritol pentamethacrylate, dipentaerythritol hexaacrylate and dipentaerythritol hexamethacrylate; a (meth)acrylic acid of a polyalcohol, such as (poly)ethyleneglocol dimethacrylate; dially maleate, diallyl fumarate, triallyl cyanurate, trially isocyanurate, diallyl phthalate, bis(acryloyloxyethyl)ether of bisphenol A, and the like. The multi-functional vinyl compound (m2) may be used alone or in combination of two or more types thereof. In addition, allyl methacrylate and triallyl cyanurate are preferred among these.

Examples of the above-mentioned other compound (m3) include a monofunctional aromatic vinyl compound, a diene compound and the like. These may be used alone or in combination of two or more types thereof.

Examples of the above-mentioned monofunctional aromatic vinyl compound include styrene, p-methyl styrene, α-methyl styrene and the like. These may be used alone or in combination of two or more types thereof. In addition, styrene is preferred among these.

Further, examples of the above-mentioned diene compound include butadiene, isoprene and the like. These may be used alone or in combination of two or more types thereof.

Regarding contents of units derived from monomers constituting the above-mentioned acryl-based rubbery polymer (a1), unit derived from a (meth)acrylic acid alkyl ester (m1), unit derived from a multi-functional vinyl compound (m2) and unit derived from other compound (m3) are preferably from 80% to 99.99% by mass, from 0.01% to 5% by mass and 0% to 19.99% by mass, more preferably from 90% to 99.5% by mass, 0.1% to 2.5% by mass and 0% to 9.9% by mass, respectively, with respect to 100% by mass of total of these. When the contents of units are in the above ranges, the effect relating to the objectives of the present invention will be achieved at a high level.

The above-mentioned rubber-reinforced vinyl-based resin (A1) is a graft copolymeric resin obtained by polymerizing a vinyl-based monomer containing an aromatic vinyl compound and a cyanidated vinyl compound in the presence of an acryl-based rubbery polymer (a1).

This vinyl-based monomer (a2) includes an aromatic vinyl compound and a cyanidated vinyl compound.

Examples of the aromatic vinyl compound include styrene, α-methyl styrene, o-methyl styrene, p-methyl styrene, vinyl toluene, vinyl xylene, ethyl styrene, dimethyl styrene, methyl-α-methyl styrene, p-tert-butyl styrene, vinyl naphthalene, methoxystyrene, monobromostyrene, dibromostyrene, fluorostyrene and the like. These compounds may be used alone or in combination of two or more types thereof. In addition, styrene and α-methyl styrene are preferred among the above-mentioned compounds.

Additionally, examples of the cyanidated vinyl compound include acrylonitrile, methacrylonitrile, α-chloro(meth)acrylonitrile and the like. These may be used alone or in combination of two or more. In addition, acrylonitrile is preferred among the above-mentioned compounds.

The above-mentioned vinyl-based monomer (a2) may be used other compound capable of copolymerizing with the aromatic vinyl compound and the cyanidated vinyl compound that are described above, in addition to these compound. Examples of the other compound include a (meth)acrylic acid ester; a malelmide compound; an unsaturated compound having a functional group such as an unsaturated acid, an unsaturated compound having epoxy group, an unsaturated compound having hydroxyl group, an unsaturated compound having oxazoline group and an unsaturated compound having acid anhydride group, and the like. These may be used alone or in combination of two or more types thereof.

Examples of the (meth)acrylic acid ester include methyl (meth)acrylate, ethyl (meth)acrylate, n-propyl (meth)acrylate, isopropyl (meth)acrylate, n-butyl (meth)acrylate, isobutyl (meth)acrylate and the like. These may be used alone or in combination of two or more types thereof. In addition, methyl methacrylate is preferred among the above-mentioned compounds.

Examples of the unsaturated acid include acrylic acid, methacrylic acid, itaconic acid, maleic acid and the like. These may be used alone or in combination of two or more types thereof.

Examples of the maleimide compound include maleimide, N-methyl maleimide, N-butyl maleimide, N-phenyl maleimide, N-cyclohexyl maleimide and the like. These may be used alone or in combination of two or more types thereof. In addition, introduction of the monomer unit of a maleimide compound into a copolymeric resin can be applied to an imidization after copolymerization with maleic anhydride.

Examples of the unsaturated compound having epoxy group include glycidyl acrylate, glycidyl methacrylate, allyl glycidyl ether and the like. These may be used alone or in combination of two or more types thereof.

The unsaturated compound having hydroxyl group includes 3-hydroxy-1-propene, 4-hydroxy-1-butene, cis-4-hydroxy-2-butene, trans-4-hydroxy-2-butene, 3-hydroxy-2-methyl-1-propene, 2-hydroxyethyl (meth)acrylate, hydroxystyrene and the like. These may be used alone or in combination of two or more type thereof.

Examples of the unsaturated compound having oxazoline group include vinyl oxazoline and the like type thereof.

Examples of the unsaturated compound having acid anhydride group include maleic anhydride, itaconic anhydride, citraconic anhydride and the like. These may be used alone or in combination of two or more type thereof.

The above-mentioned vinyl-based monomer (a2) is preferably used primarily an aromatic vinyl compound and a cyanidated vinyl compound. The total amount of these compounds is preferably in the range from 70% to 100% by mass and further preferably from 80% to 100% by mass with respect to 100% by mass of the whole vinyl-based monomer (a2). In addition, a proportion of the aromatic vinyl compound and the cyanidated vinyl compound to be used are preferably from 60% to 85% by mass and from 15% to 40% by mass, and further preferably from 70% to 80% by mass and 20% to 30% by mass, respectively, with respect to 100% by mass of the total of these compounds.

When the above-mentioned vinyl-based monomer (a2) is subjected to polymerization in the presence of the acryl-based rubbery polymer (a1), a non-grafted component wherein a residual copolymer comprising a unit derived from an aromatic vinyl compound and a unit derived from a cyanidated vinyl compound is not grafted is generated. The amount of the generated non-grafted component differs on polymerization conditions. In addition, this non-grafted component is contained in the above-mentioned component dissolved by acetonitrile.

An embodiment in which the above-mentioned acryl-based rubbery polymer reinforced resin is a mixture (A3) consisting of the above-mentioned rubber-reinforced vinyl-based resin (A1) and (co)polymer (A2) of a vinyl-based monomer (hereinafter, referred to as “vinyl-based monomer (a3)”) is described.

This (co)polymer (A2) is one obtained by polymerizing a vinyl based monomer (a3) and may be a homopolymer or a copolymer. With regard to the above-mentioned (co)polymer (A2), each of the homopolymer and the copolymer may be used alone or in combination of two or more. In addition, the homopolymer and the copolymer may be in combination. The preferred is a copolymer.

The above-mentioned vinyl-based monomer (a3) is not particularly limited so long as it has a polymerizable unsaturated bond in its molecule. An example thereof includes an aromatic vinyl compound, a cyanidated vinyl compound, a (meth)acrylic acid alkyl ester, a maleimide compound, an unsaturated compound having a functional group and the like. These monomers may be used compounds exemplified in the explanation of the above-mentioned rubber-reinforced vinyl-based resin (A1).

The above-mentioned vinyl-based monomer (a3) is preferably a compound which is the same as the vinyl-based monomer (a2) used for the formation of the above-mentioned rubber-reinforced vinyl-based resin (A1). Proportions of these monomers to be used are exactly the same.

Examples of the above-mentioned (co)polymer (A2) include acrylonitrile·styrene copolymer, acrylonitrile·α-methyl styrene copolymer, acrylonitrile·styrene·methyl methacrylate copolymer, acrylonitrile·styrene·N-phenylmaleimide copolymer and the like.

The intrinsic viscosity (measured in methylethylketone at a temperature of 30° C.) of the above-mentioned (co)polymer (A2) is preferably in the range from 0.2 to 1.2 dl/g and more preferably from 0.25 to 0.9 dl/g.

In the thermoplastic resin of the present invention, the graft ratio is in the range from 80% to 170%, preferably from 85% to 160% and further preferably from 85% to 150% both when the above-mentioned acryl-based rubbery polymer reinforced resin is a rubber-reinforced vinyl-based resin (A1), and when the resin is a mixture (A3). If the graft ratio is too low in calender molding, the state of a bank between the calender rolls may become unstable and flow marks tend to generate on the surface of the resultant film and the like. Additionally, if the graft ratio is too high, the viscosity of the thermoplastic resin of the present invention tends to be higher and formation of a film is sometimes difficult. If the graft ratio is too low in T-die molding, die streaks may be generated on the surface of a thin-walled article such as a film and a sheet, and mechanical strength is not sometimes sufficient. Additionally, if the graft ratio is too high, the viscosity of the thermoplastic resin of the present invention tends to be higher and thickness reduction is sometimes difficult. Further, if the graft ratio is too low in blown film extrusion, die streaks may be generated on the surface of a thin-walled article, and mechanical strength is not sometimes sufficient. In addition, if the graft ratio is too high, the viscosity of the thermoplastic resin of the present invention tends to be higher and thickness reduction is sometimes difficult.

The above-mentioned graft ratio refers to a value obtained by the following equation (1).

Graft ratio(% by mass)={(S−T)/T}×100 (1)

In the equation, S represents the mass (gram) of an insoluble component obtained by putting 1 gram of an acryl-based rubbery polymer reinforced resin into 20 ml of acetonitrile, shaking the mixture at a temperature of 25° C. with a shaker for 2 hours, and then centrifuging the mixture at a temperature of 5° C. with a centrifugal separator (revolution speed: 23,000 rpm) for 4 hours to separate an insoluble component and a soluble component, and T represents the mass (gram) of an acryl-based rubbery polymer (a) contained in 1 gram of the acryl-based rubbery polymer reinforced resin. The mass of the acryl-based rubbery polymer (a) can be obtained by a calculating method with polymerization formulation and polymerization conversion, a method with infrared absorption spectroscopy (IR), and the like.

The above-mentioned graft ratio can be easily controlled by appropriately selecting type and amount of the polymerization initiator, type and amount of the chain-transfer agent, addition method and addition time of the monomer component, and the like in the polymerization in the explanation for the production method of a thermoplastic resin below.

The number-average particle diameter of an acryl-based rubbery polymer (which comprises a grafted acryl-based rubbery polymer wherein a (co)polymer of the above-mentioned vinyl-based monomer (a2) is grafted on a surface of the acryl-based rubbery polymer (a1), and a non-grafted acryl-based rubbery polymer (a1)) contained (dispersed) in the acryl-based rubbery polymer reinforced resin constituting the thermoplastic resin of the present invention is in the range from 60 to 150 nm, and more preferably from 80 to 140 nm. When this number-average particle diameter is in the above range, shape stability and strength of a thin-walled article such as a film is excellent whitening resistance is also excellent upon bending. The number-average particle diameter of the acryl-based rubbery polymer may be the average value of the particle diameters measured for, e.g., 100 particles of the acryl-based rubbery polymer observed using transmission electron microscopy after immersing a thin strip composed of the thermoplastic resin of the present invention in a solution of OsO₄ or RuO₄ to color-develop.

The above-mentioned number-average particle diameter can be easily controlled by selecting appropriately particle diameter of the acryl-based rubbery polymer (a1) used upon polymerizing in the explanation for the production method of a thermoplastic resin below.

The intrinsic viscosity (measured in methylethylketone at a temperature of 30° C.) of a component dissolved by acetonitrile in the acryl-based rubbery polymer reinforced resin constituting the thermoplastic resin of the present invention is preferably in the range from 0.4 to 0.8 dl/g and more preferably from 0.5 to 0.7 dl/g. If the above-mentioned intrinsic viscosity is too low, extrudability in calender molding and the like, and appearance of the obtained thin-walled article tends to be deteriorated. In addition, if the above-mentioned intrinsic viscosity is too high, the viscosity of the thermoplastic resin of the present invention also tends to be higher and the formation of a film is sometimes difficult.

The above-mentioned intrinsic viscosity can be easily controlled by selecting appropriately types and amounts of the polymerization initiator and the chain-transfer agent that are used in production of a rubber-reinforced vinyl-based resin (A1) and a (co)polymer (A2), polymerization temperature, and the like in the explanation for the production method of a thermoplastic resin below.

The content of a bound cyanidated vinyl compound (hereinafter, referred to as “bound VC content”) in a component dissolved by acetonitrile in the acryl-based rubbery polymer reinforced resin constituting the thermoplastic resin of the present invention is preferably in the range from 20% to 30% by mass and further preferably from 22% to 28% by mass. When this bound VC content is in the above range, extrudability in calender molding and the like, and appearance of the resultant thin-walled article are excellent. The above-mentioned bound VC content can be controlled according to the ratio of the cyanidated vinyl compound which is used for the production of the rubber-reinforce vinyl-based resin (A1) and the (co)polymer (A2) in the explanation for the production method of a thermoplastic resin below. And the value can be obtained by performing liquid chromatography on a measurement sample made from a component dissolved by acetonitrile obtained during pretreatment when the graft ratio is calculated. The conditions under which the liquid chromatography is performed are described in Examples described later.

The standard deviation of the distribution of the bound VC content obtained by liquid chromatography is 5 or less, and more preferably 4 or less. If this standard deviation is too large in calender molding, the state of a bank between the calender rolls may become unstable and flow marks tend to generate on the surface of the resultant film and the like. Additionally, if this standard deviation is too large in T-die molding and blown film extrusion, undesirable phenomena such as soiling at the lip of the die and die streaks are easy to occur.

The above-mentioned standard deviation of the distribution of the bound VC content can be obtained liquid chromatography whose condition in Examples described later is applied.

The above-mentioned standard deviation of the distribution of the bound VC content can be adjusted by the proportion of a cyanidated vinyl compound in the monomer component in the reaction system as the value obtained from the copolymerization reactivity ratio in production of a rubber-reinforced vinyl-based resin (A1) and a (co)polymer (A2) in the explanation for the production method of a thermoplastic resin below.

In both cases where the thermoplastic resin of the present invention is a rubber-reinforced vinyl-based resin (A1) and is a mixture (A3), content of the acryl-based rubbery polymer contained in the thermoplastic resin of the present invention is preferably in the range from 5% to 50% by mass, and further preferably from 10% to 40% by mass. When the content of the acryl-based rubbery polymer is in this range, a physical property balance between extrudability in calender molding and the like, and impact resistance of the obtained molded article is excellent.

The thermoplastic resin of the present invention contains an acryl-based rubbery polymer reinforced resin, however, it is usually a resin consisting of this acryl-based rubbery polymer reinforced resin solely or a resin comprising this acryl-based rubbery polymer reinforced resin and other polymer components. The other case is a resin in which a formulated additive is left and contained to produce the acryl-based rubbery polymer reinforced resin stably. Examples of the other polymer component include an ABS resin, an AES resin, a polycarbonate resin, a thermoplastic polyester resin (PET, PBT and the like), a polyamide resin and the like.

The thermoplastic resin of the present invention is suitable for a molding material used in extrusion molding such as calender molding, T-die molding and blown film extrusion as the resin alone or as a composition resulting from combination with an additive and the like.

### 2. Process for the Production of the Thermoplastic Resin

The production method for the thermoplastic resin of the present invention is characterized in comprising a polymerizing step for polymerization of a vinyl-based monomer (hereinafter, referred to as “vinyl-based monomer (a2)”) containing an aromatic vinyl compound and a cyanidated vinyl compound while the vinyl-based monomer (a2) is added in the presence of an acryl-based rubbery polymer (hereinafter, referred to as “acryl-based rubbery polymer (a1)”) having a volume-average particle diameter of 60 to 150 nm, wherein a ratio of a total amount of the aromatic vinyl compound and the cyanidated vinyl compound is in the range from 70% to 100% by mass in the vinyl-based monomer (a2), wherein amounts to be used of the aromatic vinyl compound and the vinyl cyanide compound are respectively from 70% to 80% by mass and from 20% to 30% by mass with respect to 100% by mass of the total of these compounds, and wherein the polymerization is performed while polymerization conversion of the vinyl-based monomer in the reaction system is kept at 85% or more by mass. Regarding the above-mentioned acryl-based rubbery polymer (a1) and vinyl-based monomer (a2), the above description may be applied.

The production method for the thermoplastic resin of the present invention comprises further a blending step for mixing a product (graft copolymeric resin, that is to say, rubber-reinforced vinyl-based resin (A1)) obtained in the above polymerizing step and a new copolymer comprising a unit derived from an aromatic vinyl compound and a unit derived from a cyanidated vinyl compound.

As described above, the acryl-based rubbery polymer (a1) used in the above-mentioned polymerizing step is produced using the (meth)acrylic acid alkyl ester (m1) and the like. This acryl-based rubbery polymer (a1) can be obtained by publicly known emulsion polymerization while stirring a mixture of the above-mentioned monomer, an emulsifier, a polymerization initiator and water. The mixture may be formulated with a chain-transfer agent (molecular weight adjuster), an electrolyte and the like.

Regarding amounts to be used of the monomers for the above-mentioned acryl-based rubbery polymer (a1), those of (meth)acrylic acid alkyl ester (m1), multi-functional vinyl compound (m2) and other compound (m3) are preferably 80% to 99.99% by mass, 0.01% to 5% by mass and 0% to 19.99% by mass, and more preferably 90% to 99.5% by mass, 0.1% to 2.5% by mass and 0% to 9.9% by mass with respect to 100% by mass of the total of these compounds.

Examples of the emulsifier include an anionic surfactant such as an alkyl sulfonate including a salt of an alkanesulfonic acid, a salt of an alkylbenzenesulfonic acid and a salt of an alkylnaphthalenesulfonic acid; a rosinate such as an alkali metal salt (sodium salt or potassium salt) of a rosin acid (primarily abietic acid in general) including gum rosin, wood rosin, tall oil rosin and disproportionated rosins in which these are subjected to disproportionating, a purificated rosin and the like; a sulfuric acid ester of a higher alcohol; a salt of a higher alphatic calboxylic acid, a phosphate and the like; a nonionic surfactant, and the like.

The above-mentioned emulsifier is used usually in an amount from 0.1 to 10 parts by mass and preferably from 0.5 to 5 parts by mass with respect to 100 parts by mass of the total amount of the above-mentioned monomers.

Examples of the above-mentioned polymerization initiator include cumene hydroperoxide, diisopropylbenzene hydroperoxide, benzoyl peroxide, lauloyl peroxide, potassium persulfate, azobisisobutyronitrile, tert-butyl peroxylaurate, tert-butylperoxy monocarbonate and the like. These may be used alone or in combination of two or more types thereof. The above-mentioned polymerization initiator is added into the reaction system all at once or continuously. In addition, the above-mentioned polymerization initiator is used usually in an amount from 0.01 to 3 parts by mass and preferably from 0.05 to 2 parts by mass with respect to 100 parts by mass of the total amount of the above-mentioned monomers.

Examples of the above-mentioned chain-transfer agent include a mercaptan such as n-hexyl mercaptan, n-octyl mercaptan, n-dodecyl mercaptan and tert-dodecyl mercaptan; tetraethylthiuram sulfide/acrolein, methacrolein, allyl alcohol, 2-ethylhexyl thioglycol and the like. These may be used alone or in combination of two or more types thereof. In addition, the above-mentioned chain-transfer agent is used usually in an amount from 0 to 5 parts by mass and preferably from 0 to 3 parts by mass with respect to 100 parts by mass of the total amount of the above-mentioned monomers.

The volume-average particle diameter of the above-mentioned acryl-based rubbery polymer (a1) is in the range from 60 to 150 nm and more preferably from 80 to 140 nm. When this volume-average particle diameter is in the above range, shape stability and strength of the resultant thin-walled article such as a film are excellent and whitening resistance upon bending is improved. The volume-average particle diameter of the above-mentioned acryl-based rubbery polymer (a1) can be measured by a dynamic light-scattering method.

The above-mentioned volume-average particle diameter of the acryl-based rubbery polymer (a1) can be controlled by selecting appropriately type and amount of the emulsifier, type and amount of the polymerization initiator, polymerization rate (polymerization temperature, addition method of the polymerization initiator and the like), stirring rate and the like in the production of this acryl-based rubbery polymer (a1).

The gel content of the acryl-based rubbery polymer (a1) is preferably in the range from 20% to 99%, more preferably from 30% to 98%, and even more preferably from 40% to 98%. When the gel content is in the above range, a physical property balance between extrudability in calender molding and the like, and impact resistance of the obtained molded article is excellent, and the effect relating to the objectives of the present invention will be achieved at a high level.

The above-mentioned gel content can be determined by the following method. First, 1 gram of the acryl-based rubbery polymer (a1) is put into 20 ml of acetonitrile and stirred at 1,000 rpm sing a stirrer for two hours at a temperature of 25° C. Centrifugal separation is then performed for one hour using a centrifugal separator (rotational speed: 22,000 rpm), the soluble and insoluble portions are separated, the resulting insoluble portion is weighed (the mass is designated as “W grams”), and the following equation is calculated.

Gel content(%)=(W(g)/1(g))×100

The gel content can be easily controlled by appropriately selecting type and amount of the multi-functional vinyl compound, type and amount of the molecular weight adjuster, polymerization time, polymerization temperature, polymerization conversion and the like in the production of the acryl-based rubbery polymer (a1).

The above-mentioned acryl-based rubbery polymer (a1) may be used alone or in combination of two or more types thereof.

The polymerization method in the above-mentioned polymerizing step is not particularly limited and a publicly known method such as emulsion polymerization, solution polymerization, bulk polymerization and suspension polymerization may be applied. Among these, emulsion polymerization is preferred. With regard to a combination of amounts to be used of the acryl-based rubbery polymer (a1) and the vinyl-based monomer (a2), the preferable is 5 to 70 parts by mass and 30 to 95 parts by mass and further preferably 10 to 65 parts by mass and 35 to 90 parts by mass, respectively, based on 100 parts by mass of the total of these

The composition of the vinyl-based monomer (a2) used in the above-mentioned polymerizing step is as follows. That is, the aromatic vinyl compound and the cyanidated vinyl compound are used in amounts from 70% to 80% by mass and from 20% to 30% by mass, preferably from 72% to 80% by mass and from 20% to 28% by mass, and more preferably from 73% to 79% by mass and 21% to 27% by mass, respectively, with respect to 100% by mass of the total of the aromatic vinyl compound and the cyanidated vinyl compound

The polymerization in the above-mentioned polymerizing step is performed while polymerization conversion of the vinyl-based monomer (b2) in the reaction system is kept at 85% or more by mass, preferably 88% or more by masse and more preferably 90% or more by mass. When the polymerization is performed while keeping higher polymerization conversion as such, a thermoplastic resin comprising an acryl-based rubbery polymer reinforced resin having specific physical properties can be obtained.

In the case of emulsion polymerization, using method of the acryl-based rubbery polymer (a1) and the vinyl-based monomer (a2) is exemplified as below.

[1] A method in which polymerization is initiated in the presence of the whole amount of the acryl-based rubbery polymer (a1) and the whole amount of the vinyl-based monomer (a2).
[2] A method in which polymerization is conducted while adding the vinyl-based monomer (a2) dividedly or successively in the presence of the whole amount of the acryl-based rubbery polymer (a1).
[3] A method in which polymerization is initiated in the presence of the whole amount of the acryl-based rubbery polymer (a1) and a part of the vinyl-based monomer (a2), and the remainder of the vinyl-based monomer (a2) is added dividedly or successively in the middle.
[4] A method in which polymerization is initiated in the presence of a part of the acryl-based rubbery polymer (a1) and a part of the vinyl-based monomer (a2), and the remainder of the acryl-based rubbery polymer (a1) and the remainder of the vinyl-based monomer (a2) are both added dividedly or successively in the middle.
[5] A method in which polymerization is initiated in the presence of a part of the acryl-based rubbery polymer (a1) and the whole amount of the vinyl-based monomer (a2) and the remainder of the acryl-based rubbery polymer (a1) is added dividedly or successively in the middle.

The amounts to be used in the divided addition and the successive addition in the above embodiments may be variable or invariable.

Among these embodiments, methods [2], [3] and [4] are preferable and the method [2] is particularly preferable. In the methods [2] and [3], amount to be charged of the vinyl-based monomer before reaction is preferably 30% or less by mass, more preferably 20% or less by mass and further preferably more than 0% by mass and 5% or less by mass.

In the above-mentioned methods [2], [3] and [4], total addition time for the vinyl-based monomer (a2) is preferably 2 to 15 hours, and more preferably 3 to 10 hours. When the amount to be added is controlled in this range, a rubber-reinforced vinyl-based resin (A1) can be produced in a desired polymerization conversion

The above-mentioned polymerization conversion can be calculated by analyzing a reaction solution in the course of the reaction of each embodiment. The method for analysis is as follows.

[i] Approximately 2 grams of the reaction solution is precisely weighed, and 2 ml of a hydroquinone solution at a concentration of 2% by mass is added.
[ii] The above mixture is dried at 100° C. for 60 minutes to solidify. The dried material is then cooled to room temperature in a desiccator and precisely weighed.
[iii] The amount (W₁ grams) of the reaction product (the copolymer of the vinyl-based monomer (a2)) contained in the dried material is calculated from the polymerization recipe.
[iv] It is obtained from the following equation (2) using W₁ above and the amount (W₂ grams) of the vinyl-based monomer (a2) used until the collection of the reaction solution.

Polymerization conversion(% by mass)=(W₁/W₂)×100 (2)

When emulsion polymerization is performed, a polymerization initiator, an emulsifier, a chain-transfer agent (molecular weight adjusting agent), an electrolyte, water and the like are used. The emulsifier and the chain-transfer agent are not sometimes used depending on the situation, however, they are usually used.

The polymerization initiator may be used compounds exemplified in the explanation of the production method for the above-mentioned acryl-based rubbery polymer (a1). The above-mentioned polymerization initiator may be added into the reaction system all at once or continuously. In addition, the above-mentioned polymerization initiator is used usually in an amount from 0.1 to 5 parts by mass and preferably from 0.5 to 2 parts by mass with respect to 100 parts by mass of the total amount of the above-mentioned vinyl-based monomer (a2).

Regarding the emulsifier and the chain-transfer agent, compounds exemplified above may be also used. The above-mentioned emulsifier is used usually in an amount from 0.1 to 5 parts by mass and preferably from 0.1 to 3 parts by mass with respect to 100 parts by mass of the total amount of the above-mentioned vinyl-based monomer (a2). Additionally, the above-mentioned chain-transfer agent is used usually in an amount from 0.01 to 5 parts by mass and preferably from 0.05 to 3 parts by mass with respect to 100 parts by mass of the total amount of the above-mentioned vinyl-based monomer (a2).

In the above-mentioned polymerizing step, polymerization temperature in emulsion polymerization is usually in the range from 30° C. to 95° C. and preferably from 40° C. to 90° C.

For the purpose of isolating a rubber-reinforced vinyl-based resin (A1) from a latex obtained by emulsion polymerization, a coagulant including an inorganic salt such as calcium chloride, magnesium sulfate and magnesium chloride; an acid such as sulfuric acid, hydrochloric acid, acetic acid, citric acid and malic acid; and the like is added. After that, a pulverized rubber-reinforced vinyl-based resin (A1) is subjected to rinsing and drying to obtain a powder.

When the above-mentioned rubber-reinforced vinyl-based resin (A1) is produced by solution polymerization, bulk polymerization or suspension polymerization, publicly known method can be applied. In the case of solution polymerization, a vinyl-based monomer (a2) may be polymerized in the presence of a polymerization initiator while dissolving an aromatic hydrocarbon such as toluene and ethylbenzene; a ketone such as methylethylketone; an inactive solvent for polymerization such as acetonitrile, dimethylfolmamide and N-methyl pyrrolidone, or be thermal-polymerized in absence of a polymerization initiator.

The rubber-reinforced vinyl-based resin (A1) by the above-mentioned polymerizing step is sometimes a grafted acryl-based rubbery polymer in which all of the (co)polymer of the vinyl-based monomer (a2) is grafted on the surface of the acryl-based rubbery polymer (a1), however, a mixture of a grafted acryl-based rubbery polymer where a part of the (co)polymer of the vinyl-based monomer (a2) is grafted on the surface of the acryl-based rubbery polymer (a1), and a non-grafted component that is a residual (co)polymer of the vinyl-based monomer (a2) is usually obtained as described above. The content of the vinyl-based monomer (a2) remained in the above-mentioned rubber-reinforced vinyl-based resin (A1) is usually 10,000 ppm or less, and preferably 5,000 ppm or less.

When the rubber-reinforced vinyl-based resin (A1) is a final product (thermoplastic resin of the present invention), the shape thereof may be powdery, bulky (pellet) and the like.

In the method for the production of the thermoplastic resin of the present invention, a mixing step may be comprised, which mixing a rubber-reinforced vinyl-based resin (A1) obtained in the above-mentioned polymerizing step and a new copolymer comprising a unit derived from an aromatic vinyl compound and a unit derived from a cyanidated vinyl compound, as described above. This copolymer may be used a copolymer exemplified in the explanation of above-mentioned (co)polymer (A2).

The above-mentioned (co)polymer (A2) can be obtained by bulk polymerization, solution polymerization, emulsion polymerization, suspension polymerization and the like.

In the above-mentioned mixing step, a method for mixing the rubber-reinforced vinyl-based resin (A1) and the copolymer is selected according to these shapes and the like. Mixing may be performed with publicly known mixing apparatus or the like, or with a melt-kneading apparatus or the like.

The form of a thermoplastic resin obtained in the above-mentioned mixing step is powdery, bulky (pellet) or the like.

### 3. Thermoplastic Resin Composition

An additive such as an antioxidant, an ultra violet absorber, a weather resisting agent, an anti-aging agent, a filler, an anti-static agent, a flame retardant, an anti-fogging agent, a lubricant, an anti-bacterial agent, a tackiness-imparting agent, a plasticizer and a coloring agent is formulated in the thermoplastic resin of the present invention according to purposes and uses to prepare a thermoplastic resin composition.

Examples of the antioxidant include hindered amines, hydroquinones, hindered phenols, a sulfur-containing compound and the like. These may be used singly or in combination of two or more types thereof.

The content of the above-mentioned antioxidant is usually in the range from 0.05 to 5 parts by mass with respect to 100 parts by mass of the above-mentioned thermoplastic resin.

Examples of the above-mentioned ultra violet absorber include benzophenones, benzotriazoles, salicylic acid esters, metal complex salts and the like. These may be used singly or in combination of two or more types thereof.

The content of the above-mentioned ultra violet absorber is usually in the range from 0.05 to 5 parts by mass with respect to 100 parts by mass of the above-mentioned thermoplastic resin.

Examples of the weather resisting agent include an organic phosphorus-based compound, an organic sulfur-based compound, an organic compound having hydroxyl group, and the like. These may be used alone or in combination of two or more types thereof.

The content of the above-mentioned weather resisting agent is usually in the range from 0.1 to 5 parts by mass with respect to parts by mass of the above-mentioned thermoplastic resin.

Examples of the anti-aging agent include a naphtylamine-based compound, a diphenylamine-based compound, p-phenylenediamine-based compound, a quinoline-based compound, a hydroquinone-based compound, a monophenol-based compound, a bisphenol-based compound, a trisphenol-based compound, a polyphenol-based compound, a thiobisphenol-based compound, a hindered phenol-based compound, a phosphate ester-based compound, an imidazol-based compound, a dithiocarbamic acid nickel salt-based compound, a phosphate-based compound and the like. These may be used alone or in combination of two or more types thereof.

The content of the above-mentioned anti-aging agent is usually in the range from 0.05 to 5 parts by mass with respect to 100 parts by mass of the above-mentioned thermoplastic resin.

Examples of the filler include talc, titanium oxide, clay, calcium carbonate and the like. These may be used alone or in combination of two or more types thereof.

The content of the above-mentioned filler is usually in the range from 0.05 to 20 parts by mass with respect to 100 parts by mass of the above-mentioned thermoplastic resin.

Examples of the anti-static agent include a low molecular weight type anti-static agent, a polymer type anti-static agent and the like. In addition, these may be ion-conductive or electron-conductive.

Examples of the low molecular weight type anti-static agent include an anion-based anti-static agent, a cation-based anti-static agent, a nonion-based anti-static agent, an amphoteric-based anti-static agent, a complexed compound, a metal alkoxide such as an alkoxysilane, an alkoxytitanium and an alkoxyzirconium, and derivatives thereof, and the like.

In addition, examples of the polymer type anti-static agent include a vinyl copolymer having a sulfonate in its molecule, an alkylsulfonate, an alkylbenzenesulfonate, betaine and the like. A polyether, a polyamide elastomer, polyester elastomer and the like may be also used.

The content of the above-mentioned anti-static agent is usually in the range from 0.1 to 30 parts by mass with respect to 100 parts by mass of the above-mentioned thermoplastic resin.

The flame retardant includes an organic-based flame retardant, an inorganic-based flame retardant, a reactive flame retardant and the like. These may be used alone or in combination of two or more types thereof.

Examples of the organic-based flame retardant include a halogen-based flame retardant such as a brominated epoxy-based compound, a brominated alkyltriazine compound, a brominated bisphenol-based epoxy resin, a brominated bisphenol-based phenoxy resin, a brominated bisphenol-based polycarbonate resin, a brominated polystyrene resin, a brominated crosslinked polystyrene resin, a brominated bisphenol cyanurate resin, a brominated polyphenylene ether, a decabromodiphenyl oxide, and tetrabromobisphenol A and an oligomer thereof; a phosphorus-based flame retardant including a phosphoric acid ester such as trimethyl phosphate, triethyl phosphate, tripropyl phosphate, tributyl phosphate, tripentyl phosphate, trihexyl phosphate, tricyclohexyl phosphate, triphenyl phosphate, tricresyl phosphate, trixylenyl phosphate, cresyl diphenyl phosphate, dicresyl phenyl phosphate, dimethyl ethyl phosphate, methyl dibutyl phosphate, ethyl dipropyl phosphate and hydroxyphenyl diphenyl phosphate, as well as compounds obtained by modifying these compounds with various substituents, various condensed phosphoric acid ester compounds, and a phosphazene derivative comprising elemental phosphorus and nitrogen; polytetrafluoroethylene and the like. These may be used alone or in combination of two or more types thereof.

Examples of the inorganic flame retardant include aluminum hydroxide, antimony oxide, magnesium hydroxide, zinc borate, a zirconium-based compound, a molybdenum-based compound, zinc stannate, a guanidine salt, a silicone-based compound, a phosphazene-based compound and the like. These may be used singly or in combination of two or more types thereof.

Examples of the reactive flame retardant include tetrabromobisphenol A, dibromophenol glycidyl ether, a brominated aromatic triazine, tribromophenol, tetrabromophthalate, tetrachlorophthalic anhydride, dibromoneopentyl glycol, poly(penrabromobenzyl polyacrylate), chlorendic acid (HET acid), chlorendic anhydride (HET anhydride), brominated phenol glycidyl ether, dibromocresyl glycidyl ether and the like. These may be used singly or in combination of two or more types thereof.

The content of the above-mentioned flame retardant is usually in the range from 1 to 35 parts by mass with respect to 100 parts by mass of the above-mentioned thermoplastic resin.

When the flame retardant is formulated in the above-mentioned thermoplastic resin composition, it is preferable that a flame retardant auxiliary is used together. Examples of the flame retardant auxiliary include an antimony compound such as diantimony trioxide, diantimony tetraoxide, diantimony pentoxide, sodium antimonite and antimony tartrate; zinc borate, barium metaborate, alumina hydrate, zirconium oxide, ammonium polyphosphate, tin oxide, iron oxide and the like. These may be used singly or in combination of two or more types thereof.

The above-mentioned thermoplastic resin composition can be obtained by combining and kneading the above-mentioned thermoplastic resin of the present invention and the additive. Examples of kneading apparatus include an extruder (twin-screw extruder and the like), Banbury mixer, a kneader, a roll and the like. Examples of kneading methods include a method where kneading is performed while incorporating the raw material comprising the above-mentioned thermoplastic resin of the present invention all at once into a kneading apparatus, a method where kneading is performed while adding them with multi-step. Two or more kneading apparatuses may also be linked for kneading.

### 4. Molded Article

The molded article of the present invention includes the above-mentioned thermoplastic resin of the present invention. In other words, the molded article of the present invention contains at least the above-mentioned thermoplastic resin of the present invention. The molded article of the present invention is therefore obtained using the above-mentioned thermoplastic resin of the present invention or using the above-mentioned thermoplastic resin composition, and is preferably a thin-walled article such as a sheet, a film and a bag.

Regarding the above-mentioned thin-walled article, whitening is not readily appeared even upon bending, regardless of the thickness. Accordingly, even if the thin-walled article is wrapped around a irregular object, e.g., an object having corners, a favorable appearance is maintained at the bending portions. The bending portions in a colored thin-walled article can also be suppressed from whitening.

The surface of the above-mentioned thin-walled article may be flat or have a regular or irregular pattern by hairlining, embossing or the like.

The surface of the above-mentioned thin-walled article may be subjected to treatment such as a corona discharge treatment, a flame treatment, an oxidation treatment, a plasma treatment, an UV treatment, an ion bombardment treatment, an electron-beam treatment, a solvent treatment and an anchor coating treatment as necessary in order to improve printability; adhesivity or adhesiveness with a tackiness agent or an adhesive agent; adhesivity to a primer layer and the like in the above-mentioned thin-walled article.

In addition, the above-mentioned thin-walled article may be subjected to printing by a method such as gravure method, flexographic method and silk-screen method in order to impart designability, and the thin-walled article may be used as a printed film (printed sheet) or the like.

### 5 Calendar Molding

The thermoplastic resin of the present invention and the above-mentioned thermoplastic resin composition are suitable for processing into a thin-walled article such as a film having a thickness in the range from 20 to 300 μm and a sheet having a thickness in the range from 0.3 to 0.6 mm using a calender-molding apparatus, which is generally provided sequentially with steps and means for mixing a raw material including the thermoplastic resin, preliminary kneading, calender processing (rolling), cooling and winding.

In the case where the thermoplastic resin of the present invention is solely used as the raw material, the mixing step can be omitted and the process may proceed to preliminary kneading step. On the other hand, in the case where other component such as an additive is formulated into the thermoplastic resin of the present invention, the mixing step may be performed using a mixing apparatus such as Banbury mixer and the process may then proceed to the preliminary kneading step.

In the preliminary kneading step, a hot roll that is set at a temperature controlled while taking into account the melting temperature of the resin and the like, and the like are used. After that, the kneaded material is subjected to filtering with a filter or the like in order to remove foreign components and the like and fed to the calender apparatus by an extruder and the like.

In the calender processing step, a calender (apparatus) provided with two or more calender rolls, such as L-type rolls, inverted L-type rolls, Z-type rolls, inclined Z-type rolls, upright triple rolls and inclined double rolls is used. The calender (apparatus) may also be further provided with a press roll that is independent from the above-mentioned calender rolls. The molten or half-molten kneaded material that is introduced between the calender rolls is rolled out into a film or the like. The calender rolls may be heated. Additionally, when rolling is performed using a plurality of calender rolls such as L-type, inverted L-type, Z-type and inclined Z-type, the temperature may be set to decrease in each successive stage from upstream to downstream.

The rotational rate of the calender rolls is usually in the range from 10 to 60 m/min, and preferably from 15 to 50 m/min.

Further, the gap between a calender roll in the last and a calender roll second-to-last, which is important for establishing the ultimate thickness of a film or a sheet is set to be equal to or wider than the thickness of the target manufactured article. When the gap between the rolls is set to wider than the thickness of the manufactured article, the gap between the rolls is usually set in a range from 1 to 6 times the thickness of the manufactured article, and preferably in a range from 1 to 5 times thereof.

In the cooling step, the formed film or the like is cooled by, e.g., a method in which the object is sent to the next step under a low-temperature atmosphere using a cooling apparatus, an air-blasting apparatus and the like, a method in which the object is sent through cooling rolls, or the like.

A publicly known winding apparatus and the like are then used in the winding step.

According to the thermoplastic resin of the present invention and the above-mentioned thermoplastic resin composition, kneading can be smoothly conducted in the preliminary kneading step. The kneaded material can therefore be stably fed to the calender apparatus in the calender processing step. In addition, the kneaded material readily can be accumulated between the calender rolls, i.e., the state of the bank between the calender rolls can be stabilized, and therefore film formation can proceed efficiently in the calender processing step. Due to these factors, the workability during calender molding is high, and a thin-walled article can be obtained without flow marks on the surface.

### 6. T-Die Molding

The thermoplastic resin of the present invention and the above-mentioned thermoplastic resin composition are also suitable for processing into a thin-walled article such as a film having a thickness in the range from 20 to 300 μm and a sheet having a thickness in the range from 0.3 to 0.6 mm using a T-die molding apparatus.

The thin-walled article can be usually manufactured by a method provided with a soft thin-walled extrudate forming step for supplying the above-mentioned thermoplastic resin of the present invention and the above-mentioned thermoplastic resin composition in molten state to a T-die and for subjecting to T-die molding to form a soft thin-walled extrudate, and a cooling step for cooling the resulting soft thin-walled extrudate. A surface treating step for modifying the surface, a winding step for fashioning a roll conformation, a cutting step for trimming excess material on either side and fashioning a prescribed shape, and the like may also be provided as necessary after the cooling step.

In the soft thin-walled extrudate forming step, a molten (usually in the range from 180° C. to 250° C.) resin or composition is fed into a T-die (coat-hanger type, feed-block type, multi-manifold type, multi-slot type, or the like) having the desired slit gap by an extruder such as single-screw extruder and twin-screw extruder, or the like. A soft thin-walled extrudate is then discharged from the lip of the T-die. The discharge rate (processing rate) is selected according to the purpose, intended use, and the like. The soft thin-walled extrudate formed by the T-die may be monolayered or multilayered. Examples of methods for employing the molding material in the multilayered case are given below.

(1) A method in which two or more thermoplastic resins of the present invention having identical compositions are coextruded.
(2) A method in which two or more thermoplastic resins of the present invention having different compositions are coextruded.
(3) A method in which two or more of the above-mentioned thermoplastic resin compositions having identical compositions are coextruded.
(4) A method in which two or more of the above-mentioned thermoplastic resin compositions having different compositions are coextruded.
(5) A method where one thermoplastic resin of the present invention and two or more of the above-mentioned thermoplastic resin compositions are coextruded.
(6) A method where two or more thermoplastic resins of the present invention and one of the above-mentioned thermoplastic resin compositions are coextruded.

In the cooling step, the soft thin-walled extrudate is preferably cooled and hardened in an atmosphere having a lower temperature than the softening temperature of the resin or composition. This step may involve passive cooling (natural cooling), but a method for cooling and hardening may also be used in which it is made to adhere to a revolving metal belt (an endless belt or the like) or cast roll, which is made of a metal (carbon steel, stainless steel, or the like) or a non-metal (rubber or the like), controlled to the above-mentioned temperature.

The soft thin-walled article may be guided to one or more carrier rolls after the cooling step, and the process may proceed to a winding step and the like, as described above. When a surface treating step is performed, the surface treatments exemplified above may be performed, an anchor-coating agent may be applied after these surface treatments, and other treatments may be performed. In addition, the surface rate of the cast rolls of the manufacturing apparatus and the rotational rate of the carrier rolls can usually be differently controlled in order to fashion the final manufactured article into a stretched thin-walled article.

A schematic diagram will be given as an example of a manufacturing apparatus used for the production of the above-mentioned thin-walled article using a T-die.

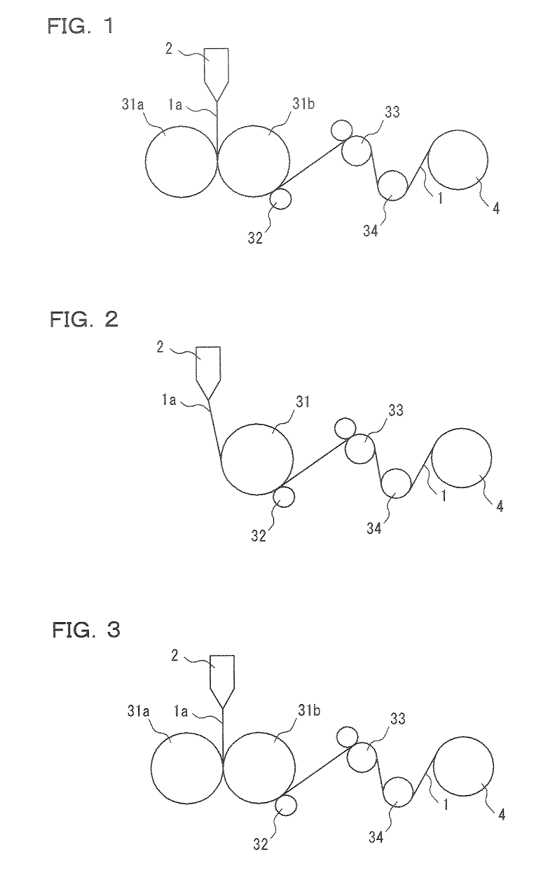

The manufacturing apparatus in FIG. 1 is provided with a T-die 2; a cast roll 31 for adhering a soft thin-walled extrudate 1a, which is discharged from the lip of the T-die 2 and allowed to fall unassisted, to the surface of the rotating roll and for cooling the soft thin-walled extrudate 1a; a plurality of carrier rolls 32, 33 and 34 that are composed of a metal or a non-metal (rubber or the like); and a winder roll 4 for winding a thin-walled article 1.

The manufacturing apparatus in FIG. 2 has the same configuration as the apparatus in FIG. 1, but it is an embodiment in which a certain distance (air gap) is present in the vertical direction from the outlet of the lip of the T-die 2 to the adhesion surface of the cast roll 31, that is to say, an embodiment in which the soft thin-walled extrudate 1a flows in a diagonal direction. When an air gap of, for example, 10 mm, 20 mm, or the like is present, the soft thin-walled extrudate 1a can be guided toward the surface of the cast roll 31 and made to adhere by a method employing an air-blasting apparatus such as air knife, and a suctioning apparatus such as low-pressure chamber having a suction inlet (none of which are shown) and the like.

The manufacturing apparatus in FIG. 3 is provided with a T-die 2; cast rolls 31a and 31b for feeding the soft thin-walled extrudate 1a, which is discharged from the lip of the T-die 2 and allowed to fall unassisted, between the two rotating rolls and for cooling the soft thin-walled extrudate 1a; a plurality of carrier rolls 32, 33 and 34; and a winder roll 4 for winding the thin-walled article 1.

In FIG. 1, linear pressure may also be applied between the cast roll 31 and the carrier roll 32 and/or between the carrier roll 33 and the carrier roll 34. The case is the same for FIGS. 2 and 3.

Additionally, the surfaces of the above-mentioned cast rolls and/or the carrier rolls may also be shaped so as to emboss, matt, or otherwise machine the surface of the thin-walled article.

It is noted that the extruder for feeding the resin or composition to the T-die 2 is not shown in FIGS. 1, 2, and 3.

### 7. Blown Film Extrusion

The thermoplastic resin of the present invention and the above-mentioned thermoplastic resin composition are also suitable for processing into a thin-walled article such as a film and a bag, having a thickness in the range from 5 to 300 μm using a blown film extrusion apparatus.

The thin-walled article can be manufactured using a method provided with a soft thin-walled article forming step for subjecting to extrusion of the above-mentioned thermoplastic resin of the present invention or the thermoplastic resin composition in molten state from an annular die to form a tubular soft thin-walled article, and a cooling step for cooling the resulting soft thin-walled article. A winding step, a cutting step, a bag-forming step, a folding step for folding in half or obtaining another result, a surface treating step for modifying the surface and the like may be provided as necessary after the cooling step. The above-mentioned thin-walled article can be manufactured using publicly known apparatuses.

In the soft thin-walled extrudate forming step, the above-mentioned thermoplastic resin of the present invention or the above-mentioned thermoplastic resin composition is put into a molten state (usually in the range from 180° C. to 250° C.) by an extruder such as single-screw extruder and twin-screw extruder, or the like, and then the resin or composition is extruded from an annular die (circular, ellipsoidal or the like) having the desired slit gap. A tubular soft thin-walled extrudate (hereinafter, referred to as “blown film bubble”) is thereby formed. The discharge rate (processing rate) from the annular die is determined by controlling the amount of the molten resin or composition to be extruded, the diameter of the die mouth, and the slit, and is selected according to the purpose, intended use and the like. The above-mentioned blown film bubble may be monolayered or multilayered. Examples of methods for employing the molding material in the multilayered case are given below.

(1) A method in which two or more thermoplastic resins of the present invention having identical compositions are coextruded.
(2) A method in which two or more thermoplastic resins of the present invention having different compositions are coextruded.
(3) A method in which two or more of the above-mentioned thermoplastic resin compositions having identical compositions are coextruded.
(4) A method in which two or more of the above-mentioned thermoplastic resin compositions having different compositions are coextruded.
(5) A method where one thermoplastic resin of the present invention and two or more of the above-mentioned thermoplastic resin compositions are coextruded.
(6) A method where two or more thermoplastic resins of the present invention and one of the above-mentioned thermoplastic resin compositions are coextruded.

A gas such as air is injected and blown from inside a blown film bubble until the blown film bubble extruded from the above-mentioned annular die is wound by a nip roll after the cooling step described below. The blow-up ratio (blown film bubble diameter/die diameter) is usually in the range from 1.1 to 20, and preferably from 1.2 to 10 on the basis of improving the stability of the blown film bubble. The direction of extrusion from the annular die is generally upward when the blown film bubble is wound at a high blow-up ratio.

In the cooling step, the blown film bubble is cooled and hardened by air cooling or water cooling. In the case of air cooling, at least one method among internal cooling and external cooling is applied. Ordinary method is external cooling with an air ring (e.g., a gas-introducing nozzle that is disposed between the nip roll and the vicinity of the outlet of the annular die). The temperature of the air is usually in the range from 10° C. to 40° C., and preferably from 10° C. to 30° C. If the temperature is too high, the stability of the blown film bubble may be deteriorated. The amount of air to be blown is selected according to the discharge rate of the blown film bubble and the like. Additionally, in the case of water cooling, a water-cooling jacket, water bath and the like are used.

After the cooling step, the resulting tubular film or tubular sheet is flattened by a nip roll and fashioned into a roll or other conformation by a take-off machine, a winder, or the like. After that, various treatments and the like are performed as necessary in order to provide the final manufactured article with prescribed properties.

For example, as previously mentioned, a plate-shaped film or other object can be machined by a cutting step, or a bag can be manufactured by a bag-forming step in which heat welding is performed on an open end of a tubular film.

In addition, when a surface treating step is performed to the surface of the film, bag and the like, the surface treatments given as examples above may be performed, an anchor-coating agent may be applied after these surface treatments, an anti-static agent may be applied, or other treatments may be performed.

### 8. Composite Article

The molded article obtained using the above-mentioned thermoplastic resin of the present invention or the thermoplastic resin composition may be integrated with other molded articles, members, or like and fashioned into a complexed article.

The composite article of the present invention is characterized in having a molded part (hereinafter, referred to as “molded part [X]”) comprising the above-mentioned thermoplastic resin of the present invention; and a portion (hereinafter, referred to as “portion [Y]”) comprising at least one material selected from the group consisting of an organic material and an inorganic material, disposed on at least one part of a surface of this molded part [X].

The composite article of the present invention may be one where the molded part [X] is a base or one where the portion [Y] is a base, depending on the purpose and intended use. Examples of the former case may include a tacky film, an adhesive film, a tacky sheet, an adhesive sheet, a layered film, a layered sheet and the like. Examples of the latter case may include an exterior material for home electronics products and the like; an interior material disposed primarily within homes and other buildings and the like.

The composite article of the present invention may also comprise other portions, layers, or the like between the above-mentioned molded part [X] and the above-mentioned portion [Y].

The above-mentioned molded part [X] is preferably a thin-walled article. The surface of the thin-walled article may have a convex part, a concave part, a through-hole, a groove and the like. The surface may also be treated.

A polymer is usually used when the material constituting the above-mentioned portion [Y] is an organic material. The polymer is selected according to the purpose. Wood or synthetic wood may also be used. The polymer may be a thermoplastic polymer, a cured polymer, or a polymer having other properties. Examples of the inorganic material include a metal, an alloy, an oxide, a carbide, a nitride, a salt and the like. In addition, a reinforced material in which particles composed of an inorganic material are dispersed in a polymer matrix may also be used as a material containing organic and inorganic materials.

In the case where the above-mentioned organic material is a thermoplastic polymer, the organic material may also be the above-mentioned thermoplastic resin of the present invention.

The shape of the above-mentioned portion [Y] may be that of a thin-walled article, plate, sphere, container, tube, clump, or other shape, or the portion [Y] may have an indefinite shape. The shape is selected according to the purpose. The surface may have a convex part, a concave part, a through-hole, a groove and the like.

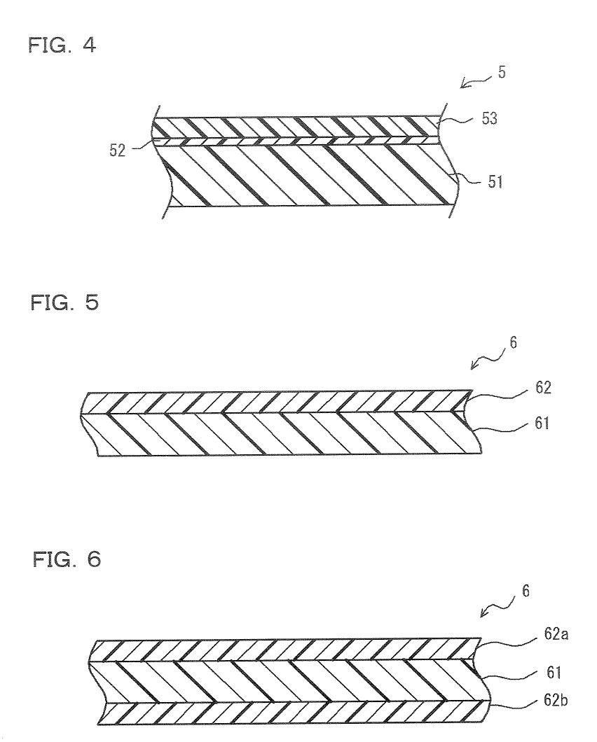

When the composite article of the present invention is a tacky film used for a label, a wallpaper or the like, that is to say, a tacky film having the molded part [X](a film or a sheet) and a tackiness layer provided on at least one surface of this molded part [X], the composite article can be produced by disposing a tackifier composition or the like on at least one surface of the molded part [X] and forming a tackiness layer. The thickness of the tackiness layer is usually in the range from 1 to 100 μm Examples of the tackifier composition include an emulsion type for coating by screen method, gravure method, mesh method, bar coating method and the like; an organic solvent type; a heat fusion type leading to formation by extrusion lamination method, dry lamination method, coextrusion method and the like; and the like. Any of these types may be used. Examples may include compositions containing an acryl-based polymer, a diene-based polymer or the like that are well known. In order to improve adhesiveness between the molded part [X] and the tackifier composition, an anchor-coat layer may be formed either directly on the molded part [X] or after the surface of the molded part [X] has been subjected to corona treatment or the like (see FIG. 4). In the latter case, the layer is very thin at a thickness of approximately in the range from 0.1 to 5 μm and contains a resin such as polyethyleneimine, polyurethane, polyester and an acrylic resin. The above-mentioned layer can be formed by applying an aqueous solution or a solvent solution, and drying. When the anchor-coat layer is formed, workability in applying a composition for forming the tacky layer, smoothness of the tacky layer formed, and the like can be improved. A further step for disposing a release paper or the like as a protective layer for protecting these layers is usually required after the formation of the tacky layer.

The composite article in FIG. 4 is a schematic cross-sectional diagram that shows a tacky film 5, and sequentially comprises a thin-walled article 51 comprising the above-mentioned thermoplastic resin of the present invention or the above-mentioned thermoplastic resin composition, an anchor-coat layer 52; and a tacky layer 53.

In the case where the thin-walled article is manufactured by calender molding and the tacky film is then manufactured by a series of steps, a method can be applied in which a tackifier composition is coated on at least one surface of the rolled-out film or the like just before the above-mentioned cooling step to form a tacky layer, or another method can be applied. A further step for disposing release paper or the like is usually necessary in this case, as well.

Further, in the case where the composite article of the present invention is an adhesive film, an adhesive layer can be formed on the surface of the above-mentioned molded part [X] using an adhesive composition comprising an epoxy resin, a phenol resin, an acryl-based resin or the like, in the same manner as the case of the tacky film. However, when the adhesive layer is not used immediately after formation, the adhesive layer must be in a state where the bonding capability does not manifest. The thickness of the adhesive layer is usually in the range from 1 to 100 μm. The cross-sectional structure of the adhesive film may also be identical to that shown in FIG. 4.

In addition, when T-die molding is applied and the above-mentioned thermoplastic resin of the present invention or the above-mentioned thermoplastic resin composition in combination with one or more other types of thermoplastic resin compositions are coextruded, a layered article such as a layered film and a layered sheet can be formed. Die streaks on the surface of the layer comprising the above-mentioned thermoplastic resin of the present invention or the above-mentioned thermoplastic resin composition can also be minimized in these cases, where coextrusion with another composition is performed.

Moreover, when blown film extrusion is applied and the above-mentioned thermoplastic resin of the present invention or the above-mentioned thermoplastic resin composition in combination with one or more other types of thermoplastic resin compositions are coextruded, a layered blown film bubble is formed, after which steps as described above are performed, whereby a layered film a bag and the like can be manufactured. Die streaks on the surface of the layer comprising the above-mentioned thermoplastic resin of the present invention or the above-mentioned thermoplastic resin composition can also be minimized in these cases, where coextrusion with another composition is performed.

Furthermore, a thin-walled article (portion [Y]) comprising the above-mentioned thermoplastic resin of the present invention, the above-mentioned thermoplastic resin composition, or other thermoplastic resin composition may also be laminated on one or both surfaces of the thin-walled article (molded part [X]) manufactured using the above-mentioned thermoplastic resin of the present invention or the above-mentioned thermoplastic resin composition.

The composite article in FIG. 5 is a schematic cross-sectional diagram that shows a layered sheet 6 and is provided with a thin-walled article 61 comprising the above-mentioned thermoplastic resin of the present invention or the above-mentioned thermoplastic resin composition, and a molded part 62 that comprises other thermoplastic resin composition or the like and that is joined to one surface of the thin-walled article 61.

In addition, the composite article in FIG. 6 is a schematic cross-sectional diagram that shows another example of the layered sheet 6 and is provided with a thin-walled article 61 comprising the above-mentioned thermoplastic resin of the present invention or the above-mentioned thermoplastic resin composition, and molded parts 62a and 62b that are comprising other thermoplastic resin composition or the like and that are joined to both surfaces of the thin-walled article 61.

Whether the composite article of the present invention is a layered sheet or a layered film, whitening does not readily occur in a thin-walled article comprising the above-mentioned thermoplastic resin of the present invention or the above-mentioned thermoplastic resin composition even upon bending, regardless of thickness. Therefore, even if the thin-walled article is wrapped around an object having an irregular shape, e.g., having corners, a favorable appearance is maintained at the points of bending. Whitening at points of bending can also be minimized in colored thin-walled articles.

Moreover, the composite article of the present invention can be used even in cases that do not involve combinations of resins, e.g., in an external part for home electronics products, machines, common objects and the like, a panel, a display and the like. It is advantageously used based on the properties where the molded part [X] which comprises the above-mentioned thermoplastic resin of the present invention or the above-mentioned thermoplastic resin composition, and minimizes whitening due to bending or the like, and the portion [Y] may be applied as a support (a support plate or an inset frame). Another portion, e.g., a tacky layer, an adhesive layer and the like may be provided between the molded part [X] and the portion [Y] in such instances, as well.

### EXAMPLES

The present invention is described in detail hereinafter using examples. In the following examples, “part” and “%” are based on mass unless otherwise indicated.

### 1. Production and Evaluation of Thermoplastic Resin

### 1-1. Production of Rubber-Reinforced Vinyl-Based Resin (A1)

Acryl-based rubbery polymers used for producing rubber-reinforced vinyl-based resins (A1) are as follows.

(1) a1-1

It is an acryl-based rubbery polymer which is obtained by emulsion polymerization of 99 parts of n-butyl acrylate and 1 part of allyl methacrylate, and has a volume-average particle diameter of 100 nm, and a gel content of 90%.

(2) a1-2

It is an acryl-based rubbery polymer which is obtained by emulsion polymerization of 99 parts of n-butyl acrylate and 1 part of allyl methacrylate, and has a volume-average particle diameter of 40 nm, and a gel content of 90%.

(3) a1-3

It is an acryl-based rubbery polymer which is obtained by emulsion polymerization of 99 parts of n-butyl acrylate and 1 part of allyl methacrylate, and has a volume-average particle diameter of 300 nm, and a gel content of 90%.

(4) a1-4

It is an acryl-based rubbery polymer which is obtained by emulsion polymerization of 99 parts of n-butyl acrylate and 1 part of allyl methacrylate, and has a volume-average particle diameter of 320 nm, and a gel content of 90%.

(5) a1-5

It is a polybutadiene rubbery polymer having a volume-average diameter of 110 nm and a gel content of 90%.

### Synthesis Example 1

50 parts (corresponding to solids content) of a latex having a solids concentration of 40% and containing an acryl-based rubbery polymer (a1-1) was charged into a reaction vessel, and then diluted by adding 1 part of sodium dodecylbenzene sulfonate and 150 parts of ion-exchanged water. An inside of the reaction vessel was then replaced with nitrogen gas. 0.02 part of disodium ethylene diamine tetraacetate, 0.005 part of ferrous sulfate, and 0.3 part of sodium formaldehyde sulfoxylate were added, and the temperature was raised to 60° C. while stirring.

Meanwhile, 1.0 part of terpinolene and 0.2 part of cumene hydroperoxide were dissolved in 50 parts of a mixture of 37.5 parts of styrene and 12.5 parts of acrylonitrile in a container. An inside of the container was then replaced with nitrogen gas, and a monomer composition was obtained.

Subsequently, polymerization was conducted at 70° C. while the monomer composition was added to the reaction vessel at a constant flow volume over five hours. After the addition of the monomer composition, polymerization was continued for another hour to obtain. Magnesium sulfate was added to this latex and a resin component was made to coagulate. Washing with water and drying were then performed, whereby a rubber-reinforced acrylonitrile-styrene-based resin (A1-1) was obtained.

The polymerization conversions at one, two, three, four and five hours from when the monomer composition was initially added were 92% to 93% in all instances, and the polymerization conversion after the reaction was 96%.

### Synthesis Example 2

A rubber-reinforced acrylonitrile·styrene-based resin (A1-2) was obtained in the same manner as Synthesis Example 1, except that the usage amounts shown in Table 1 were used for the acryl-based rubbery polymer (a1-1), acrylonitrile and styrene.

The polymerization conversions at one, two, three, four and five hours from when the monomer composition was initially added were 92% to 93% in all instances, and the polymerization conversion after the reaction was 96%.

### Synthesis Example 3

A rubber-reinforced acrylonitrile-styrene-based resin (A1-3) was obtained in the same manner as Synthesis Example 1, except that the acryl-based rubbery polymer (a1-2) was used instead of the acryl-based rubbery polymer (a1-1).

### Synthesis Example 4

A rubber-reinforced acrylonitrile-styrene-based resin (A1-4) was obtained in the same manner as Synthesis Example 1, except that the acryl-based rubbery polymer (a1-3) was used instead of the acryl-based rubbery polymer (a1-1).

### Synthesis Example 5

A rubber-reinforced acrylonitrile·styrene-based resin (A1-5) was obtained in the same manner as Synthesis Example 1, except that the usage amount of terpinolene was 1.5 parts.

### Synthesis Example 6

A rubber-reinforced acrylonitrile·styrene-based resin (A1-6) was obtained in the same manner as Synthesis Example 2, except that the addition period was 8 hours.

### Synthesis Example 7

A rubber-reinforced acrylonitrile-styrene-based resin (A1-7) was obtained in the same manner as Synthesis Example 6, except that the usage amount of terpinolene was 1.5 parts.

### Synthesis Example 8

A rubber-reinforced acrylonitrile-styrene-based resin (A1-8) was obtained in the same manner as Synthesis Example 6, except that the usage amount of terpinolene was 0.3 part.

### Synthesis Examples 9 to 10

Rubber-reinforced acrylonitrile-styrene-based resins (A1-9) and (A1-10) were obtained in the same manner as Synthesis Example 1, except that the usage amounts shown in Table 1 were used for the acryl-based rubbery polymer (a1-1), acrylonitrile and styrene.

### Synthesis Example 11

A rubber-reinforced vinyl-based resin (A1-11) was obtained in the same manner as Synthesis Example 1, except that the acryl-based rubbery polymer (a1-4) was used instead of the acryl-based rubbery polymer (a1-1)

### Synthesis Example 12

A rubber-reinforced vinyl-based resin (A1-12) was obtained in the same manner as Synthesis Example 1, except that the usage amounts shown in Table 1 were used for the acryl-based rubbery polymer (a1-1), acrylonitrile and styrene.

### Synthesis Example 13

A rubber-reinforced vinyl-based resin (A1-13) was obtained in the same manner as Synthesis Example 1, except that the usage amounts shown in Table 1 were used for the acryl-based rubbery polymer (a1-1), acrylonitrile and styrene.

### Synthesis Example 14

A rubber-reinforced vinyl-based resin (A1-14) was obtained in the same manner as Synthesis Example 2, except that polybutadiene rubbery polymer (a1-5) was used instead of the acryl-based rubbery polymer (a1-1).

TABLE 1

| | | | | Synthesis Example | | | | | | | | | | | | | |
|---|---|---|---|---|---|---|---|---|---|---|---|---|---|---|---|---|---|
| | | | | 1 | 2 | 3 | 4 | 5 | 6 | 7 | 8 | 9 | 10 | 11 | 12 | 13 | 14 |
| Rubber-reinforced | | | | A1-1 | A1-2 | A1-3 | A1-4 | A1-5 | A1-6 | A1-7 | A1-8 | A1-9 | A1- | A1- | A1- | A1- | A1- |
| vinyl-based resin | | | | | | | | | | | | | 10 | 11 | 12 | 13 | 14 |
| (A1) | | | | | | | | | | | | | | | | | |
| Formulation | Acryl-based | | Volume- | | | | | | | | | | | | | | |
| (parts) | rubbery | | average | | | | | | | | | | | | | | |
| | polymer | | particle | | | | | | | | | | | | | | |
| | | | diameter | | | | | | | | | | | | | | |
| | | a1-1 | 100 nm | 50 | 22.5 | | | 50 | 22.5 | 22.5 | 22.5 | 22.5 | 22.5 | | 22.5 | 22.5 | |
| | | a1-2 | 40 nm | | | 50 | | | | | | | | | | | |
| | | a1-3 | 300 nm | | | | 50 | | | | | | | | | | |
| | | a1-4 | 320 nm | | | | | | | | | | | 50 | | | |
| | Poly- | a1-5 | 110 nm | | | | | | | | | | | | | | 22.5 |
| | butadiene | | | | | | | | | | | | | | | | |
| | rubbery | | | | | | | | | | | | | | | | |
| | polymer | | | | | | | | | | | | | | | | |

| | | | | | | | | | | | | | | | |
|---|---|---|---|---|---|---|---|---|---|---|---|---|---|---|---|
| Vinyl-based | Styrene | 37.5 | 58 | 37.5 | 37.5 | 37.5 | 58 | 58 | 58 | 64.5 | 52 | 37.5 | 67.5 | 47.5 | 58 |
| monomer | Acrylonitrile | 12.5 | 19.5 | 12.5 | 12.5 | 12.5 | 19.5 | 19.5 | 19.5 | 13 | 25.5 | 12.5 | 10 | 30 | 19.5 |

### 1-2. Preparation of Thermoplastic Resin and Evaluation for Calender Molding

Thermoplastic resins were prepared using the rubber-reinforced vinyl-based resins (A1) obtained above and acrylonitrile·styrene copolymers (A2) below and were subjected to calender molding. Then various evaluations were performed.

### (1) A2-1

Acrylonitrile·styrene copolymer having a bound AN content of 24.0% was used. The intrinsic viscosity (measured in methylethylketone at a temperature of 30° C.) is 0.45 dl/g.

### (2) A2-2

Acrylonitrile·styrene copolymer having a bound AN content of 32.0% was used. The intrinsic viscosity (measured in methylethylketone at a temperature of 30° C.) is 0.45 dl/g.

### Experimental Example 1-1

First, the rubber-reinforced vinyl-based resin (A1-1) and the acrylonitrile-styrene copolymer (A2-1) were mixed using Henschel mixer in the proportions described in Table 2. The mixture was then charged into a twin-screw extruder and melt-kneaded at a temperature in the range from 200° C. to 240° C. to obtain pellets (thermoplastic resin). Graft ratio and intrinsic viscosity (measured in methylethylketone at a temperature of 30° C.) of a component dissolved by acetonitrile for this resin were measured by the methods shown above. Additionally, the component dissolved by acetonitrile was subjected to high performance liquid chromatography to measure the bound acrylonitile content (bound AN content) and standard deviation of the distribution of the bound AN content according to methods below. These properties are shown in Table 2.

### <Method for Measuring Bound Acrylonitrile Content (Bound an Content) and Standard Deviation of Distribution Thereof>

20 mg of the component dissolved by acetonitrile was dissolved in 5 ml of a mixed solvent of acetonitrile and 1,2-dichloroethane in a 6/4 volumetric ratio and let to stand for 24 hours. After that, filtering was performed using a 0.5 μm filter, and a sample for liquid chromatography was prepared. This sample was analyzed under the conditions below, and the bound AN content and the standard deviation of the distribution thereof were obtained from the elution percent and acrylonitrile content using the resulting elution curve. An acrylonitrile-styrene copolymer whose content of bound AN was determined by CHN elemental analysis was used as a standard sample.

| | |
|---|---|
| Column | TGKgel Silica-60 (15 cm) manufactured by TOSOH |
| | Corp. |
| Eluate | A liquid: n-heptane/1,2-dichloroethane |
| | (7/3 volumetric ratio) |
| | B liquid: acetonitrile/1,2-dichloroethane |
| | (6/4 volumetric ratio) |
| Gradient condition | B liquid; 25% −> 100% (19 min., linear gradient), |
| | 100% (10 min., hold), 100% −> 25% (5 min., linear |
| | gradient), 25% (5 min., hold) |
| Flow rate | 1 ml/min. |
| Column temperature | 30° C. |
| Injection volume | 20 μl |
| Detector | UV (wavelength at 260 nm) |

A film was manufactured by the method below using the above-mentioned pellets.

First, the above-mentioned pellets were melted at a temperature in the range from 180° C. to 190° C. and kneaded using hot rolls. The kneaded material was then fed into an extruder having five filters of 20, 60, 350, 60 and 20 mesh. Rolling was performed using a calender apparatus provided with four inverted L-type calender rolls adjusted to a temperature of 185° C. to fabricate a film having a thickness of 100 μm

The evaluation items were as follows, and the results are shown in Table 2.

### (1) Roll Kneadability

Kneading state by the hot rolls was observed and evaluated based on the following criteria.

⊚: Extremely good.

### ◯: Good.

### X: Poor.

### XX: Inferior.

### (2) State of Bank Between Calender Rolls

The accumulation of molten material between the calender rolls was observed during the manufacture of the film and evaluated based on the following criteria.

⊚: The molten material stably and adequately accumulated, being extremely good.
◯: The molten material stably accumulated, being good.
X: The accumulation of molten material was inadequate.
XX: The accumulation of molten material was unstable.

### (3) Flow Marks on Film Surface

Irregularity in the luster of the surface of the resulting film was observed and evaluated based on the following criteria.

⊚: Absolutely no irregularities, being extremely good.
◯: Few irregularities, being good.
X: Definite irregularities, being poor.
XX Irregularities over the whole surface, being inferior.

### (4) Whitening Resistance Upon Film Bending

The resulting film was bent 180° at a temperature of 230C. The bent portion was observed and evaluated based on the following criteria.

◯Little whitening, being good.
X: Definite whitening, being inferior.

### Experimental Example 1-2

Pellets were obtained in the same manner as in Experimental Example 1-1, except that the rubber-reinforced vinyl-based resin (A1-2) was solely used as the thermoplastic resin. After that, a film was manufactured and evaluated in the same manner as Experimental Example 1-1. The results are listed in Table 2.

### Experimental Examples 1-3 to 1-11

Pellets were obtained in the same manner as Experimental Example 1-1, except that the types and proportions of the rubber-reinforced vinyl-based resins (A1) and the acrylonitrile-styrene copolymers (A2) described in Table 2 were used. After that, films were manufactured and evaluated in the same manner as Experimental Example 1-1. The results are listed in Table 2.

TABLE 2

| | | | | Experimental Example | | | | | |
|---|---|---|---|---|---|---|---|---|---|
| | | | | 1-1 | 1-2 | 1-3 | 1-4 | 1-5 | 1-6 |
| Thermoplastic | Formulation | Rubber-reinforced | A1-1 | 45 | | | | | |
| resin | (parts) | vinyl-based resin | A1-2 | | 100 | | | | |
| | | (A1) | A1-3 | | | 45 | | | |
| | | | A1-4 | | | | 45 | | |
| | | | A1-5 | | | | | 45 | |
| | | | A1-6 | | | | | | 100 |
| | | | A1-7 | | | | | | |
| | | | A1-8 | | | | | | |
| | | | A1-9 | | | | | | |
| | | | A1-10 | | | | | | |
| | | Acrylonitrile-styrene | A2-1 | 55 | | 55 | 55 | 55 | |
| | | copolymer (A2) | A2-2 | | | | | | |

| | | | | | | | |
|---|---|---|---|---|---|---|---|
| Property | Graft ratio (%) | 85 | 120 | 85 | 100 | 40 | 200 |
| | Number-average particle diameter of | 110 | 110 | 50 | 320 | 110 | 120 |
| | acryl-based rubbery polymer (nm) | | | | | | |

| | | | | | | | |
|---|---|---|---|---|---|---|---|
| Component | Intrinsic | 0.45 | 0.55 | 0.45 | 0.52 | 0.52 | 0.47 |
| dissolved by | viscosity | | | | | | |
| acetonitrile | (dl/g) | | | | | | |
| | Bound | 24.0 | 24.5 | 24.0 | 24.1 | 24.0 | 24.3 |
| | AN content | | | | | | |
| | (%) | | | | | | |

| | | | | | | | |
|---|---|---|---|---|---|---|---|
| | Standard deviation σ of | 3.1 | 2.9 | 3.3 | 3.2 | 2.8 | 3.5 |
| | bound AN content | | | | | | |
| Evaluation | Roll kneadability | ◯ | ⊚ | X | X | X | X |
| in calender | Bank state between calender rolls | ◯ | ⊚ | X | X | X | X |
| molding | Flow mark on film surface | ◯ | ⊚ | X | X | X | X |
| | Whitening resistance | ◯ | ◯ | ◯ | X | ◯ | ◯ |

| | | | | Experimental Example | | | | |
|---|---|---|---|---|---|---|---|---|
| | | | | 1-7 | 1-8 | 1-9 | 1-10 | 1-11 |
| Thermoplastic resin | Formulation (parts) | Rubber-reinforced | A1-1 | | | 45 | | |
| | | vinyl-based resin | A1-2 | | | | | |
| | | (A1) | A1-3 | | | | | |
| | | | A1-4 | | | | | |
| | | | A1-5 | | | | | |
| | | | A1-6 | | | | | |
| | | | A1-7 | 100 | | | | |
| | | | A1-8 | | 100 | | | |
| | | | A1-9 | | | | 100 | |
| | | | A1-10 | | | | | 100 |
| | | Acrylonitrile-styrene | A2-1 | | | | | |
| | | copolymer (A2) | A2-2 | | | 55 | | |

| | | | | | | |
|---|---|---|---|---|---|---|
| Property | Graft ratio (%) | 85 | 90 | 85 | 85 | 90 |
| | Number-average particle diameter | 120 | 120 | 110 | 120 | 120 |
| | of acryl-based rubbery polymer | | | | | |
| | (nm) | | | | | |

| | | | | | | |
|---|---|---|---|---|---|---|
| Component | Intrinsic | 0.25 | 0.85 | 0.45 | 0.45 | 0.55 |
| dissolved by | viscosity | | | | | |
| acetonitrile | (dl/g) | | | | | |
| | Bound | 24.2 | 24.1 | 28.5 | 18.5 | 32.5 |
| | AN content | | | | | |
| | (%) | | | | | |

| | | | | | | |
|---|---|---|---|---|---|---|
| | Standard deviation σ of | 2.9 | 3.2 | 6.2 | 2.9 | 3.5 |
| | bound AN content | | | | | |
| Evaluation | Roll kneadability | X | X | XX | XX | XX |
| in calender | Bank state between calender rolls | X | X | XX | XX | XX |
| molding | Flow mark on film surface | X | X | XX | XX | XX |
| | Whitening resistance | ◯ | ◯ | ◯ | ◯ | ◯ |

Experimental Examples 1-3 and 1-4 were examples in which number-average particle diameters of the acryl-based rubbery polymers present (dispersed) in the thermoplastic resins were out of the range based on the present invention. Experimental Examples 1-5 and 1-6 were examples in which graft ratios were out of the range based on the present invention. Experimental Examples 1-7 and 1-8 were examples in which intrinsic viscosities of the component dissolved by acetonitrile were out of the range based on the present invention. Experimental Example 1-9 was an example in which standard deviation of the bound AN content was out of the range based on the present invention. Further, Experimental Examples 1-10 and 1-11 were examples in which bound AN contents were out of the range based on the present invention. In all of these cases, roll kneadability and the state of the bank between the calender rolls were inferior, and flow marks were observed on the surface of the films.

On the other hand, Experimental Examples 1-1 and 1-2 had an excellent balance among categories for evaluation.

### 1-3. Preparation of Thermoplastic Resin and Evaluation for T-Die Molding

Thermoplastic resins were prepared using the above-mentioned rubber-reinforced vinyl-based resins (A1) and the acrylonitrile-styrene copolymers (A2) and were subjected to T-die molding. Then various evaluations were performed.

### Experimental Example 2-1

First, the rubber-reinforced vinyl-based resin (A1-1) and the acrylonitrile-styrene copolymer (A2-1) were mixed using Henschel mixer in the proportions described in Table 3. The mixture was then charged into a twin-screw extruder and melt-kneaded at a temperature in the range from 200° C. to 240° C. to obtain pellets (thermoplastic resin). Graft ratio, intrinsic viscosity of a component dissolved by acetonitrile, bound acrylonitile content (bound AN content) and standard deviation of the distribution of the bound AN content for this resin were measured in the same manner mentioned above. These properties are shown in Table 3.

A film was manufactured by the method below using the above-mentioned pellets.

First, the above-mentioned pellets were fed into an extruder having a screw diameter of 50 mm and provided with a T-die (die width: 300 mm; lip gap: 1.5 mm). The resin was discharged from the T-die at a melting temperature of 200° C. to obtain a soft film. The soft film was then made to adhere to the surface of a cast roll (surface temperature of the roll: 50° C.) using an air knife. The operation proceeded so as to yield the thickness shown in Table 3, and a film was obtained by cooling and hardening.

The above-mentioned melting temperature was measured using a thermocouple thermometer. Additionally, as for the thickness of the film, after one hour had elapsed from initiation of the manufacture for the film, the film was cut away, the thickness was measured using a thickness gauge (Type “ID-C1112C” manufactured by Mitutoyo Corporation) at 10-mm intervals from the center of the film in the widthwise direction towards both ends, and the average value was determined. The values of measurement points in ranges within 20 mm of the edge parts of the film were removed from the calculation of this average value.

The evaluation categories were as follows, and the results are shown in Table 3.

### (1) Soiling at Lip of Die

The presence or absence of soiling (plate-out) at the lip of the die one hour after film manufacture commenced was visually evaluated.

### (2) Die Streaks

The presence or absence of die streaks on the surface of the film one hour after film manufacture commenced was visually evaluated.

◯: Die streaks were not occurred.
Δ: Large amount of light die streaks were occurred
X: Dense die streaks were occurred.

### (3) Adhesivity

In the resulting film, the state of the surface that adhered to the cast roll was visually evaluated.

◯: The entire surface of the film was lustrous, and adhesion was good.
Δ: Non-lustrous regions in film edge regions; poor adhesion.
X: Non-lustrous regions on film surface; poor unsatisfactory.

### (4) Whitening Resistance Upon Film Bending

The resulting film was bent 180° at a temperature of 23° C. The bent portion was observed and evaluated based on the following criteria.

◯: Little whitening, being good.
X: Definite whitening, being inferior.

### Experimental Example 2-2

A film was manufactured an evaluated in the same manner as Experimental Example 2-1 except that the pellets of the rubber-reinforced vinyl-based resin (A1-2) was used. The results are listed in Table 3.

### Experimental Examples 2-3 to 2-8

Pellets were obtained in the same manner as Experimental Example 2-1, except that the types and proportions of the rubber-reinforced vinyl-based resins (A1) and the acrylonitrile-styrene copolymers (A2) described in Table 3 were used. After that, films were manufactured and evaluated in the same manner as Experimental Example 2-1. The results are listed in Table 3.

TABLE 3

| | | | | Experimental Example | | | | | | | |
|---|---|---|---|---|---|---|---|---|---|---|---|
| | | | | 2-1 | 2-2 | 2-3 | 2-4 | 2-5 | 2-6 | 2-7 | 2-8 |
| Thermoplastic | Formulation (parts) | Rubber-reinforced | A1-1 | 45 | | | | 45 | | | |
| resin | | vinyl-based resin | A1-2 | | 100 | | | | | | |
| | | (A1) | A1-3 | | | 45 | | | | | |
| | | | A1-11 | | | | 45 | | | | |
| | | | A1-12 | | | | | | 100 | | |
| | | | A1-13 | | | | | | | 100 | |
| | | | A1-14 | | | | | | | | 100 |
| | | Acrylonitrile-styrene | A2-1 | 55 | | 55 | 55 | | | | |
| | | copolymer (A2) | A2-2 | | | | | 55 | | | |

| | | | | | | | | | |
|---|---|---|---|---|---|---|---|---|---|
| Property | Graft ratio (%) | 85 | 120 | 85 | 100 | 85 | 85 | 90 | 125 |
| | Number-average particle diameter | 110 | 110 | 50 | 330 | 110 | 120 | 120 | 115 |
| | of acryl-based rubbery polymer | | | | | | | | |
| | (nm) | | | | | | | | |

| | | | | | | | | | |
|---|---|---|---|---|---|---|---|---|---|
| Component | Intrinsic | 0.45 | 0.55 | 0.45 | 0.52 | 0.45 | 0.45 | 0.55 | 0.55 |
| dissolved by | viscosity | | | | | | | | |
| acetonitrile | (dl/g) | | | | | | | | |
| | Bound | 24.0 | 24.5 | 24.0 | 24.1 | 28.5 | 14.5 | 40.5 | 24.5 |
| | AN content | | | | | | | | |
| | (%) | | | | | | | | |

| | | | | | | | | | |
|---|---|---|---|---|---|---|---|---|---|
| | Standard deviation σ of | 3.1 | 2.9 | 3.3 | 3.2 | 6.2 | 2.9 | 3.5 | 2.9 |
| | bound | | | | | | | | |
| | AN content | | | | | | | | |
| Evaluation | Film thickness (μm) | 100 | 150 | 100 | 80 | 100 | 150 | 80 | 100 |
| in T-die | Soiling at lip of the die | ◯ | ◯ | X | X | X | X | X | X |
| molding | Die streaks | ◯ | ◯ | Δ | X | X | X | X | X |
| | Adhesivity | ◯ | ◯ | ◯ | ◯ | ◯ | Δ | ◯ | ◯ |
| | Whitening resistance | ◯ | ◯ | ◯ | X | ◯ | X | ◯ | X |

It is clear from Table 3. In Experimental Example 2-3 wherein an acryl-based rubbery polymer having smaller volume-average particle diameter than that of the range based on the present invention was used, adhesivity to the cast roll and whitening resistance were good, but soiling at the lip of the die and die streaks were occurred. In Experimental Example 2-4 wherein an acryl-based rubbery polymer having larger volume-average particle diameter than that of the range based on the present invention was used, soiling at the lip of the die and die streaks were occurred, and whitening resistance was also inferior. In Experimental Example 2-5 wherein a larger deviation of the bound AN content than that of the range based on the present invention was used, soiling at the lip of the die and die streaks were occurred. In Experimental Example 2-6 wherein a smaller bound AN content than that of the range based on the present invention was used, soiling at the lip of the die and die streaks were occurred, and adhesivity and whitening resistance were inferior as well. In Experimental Example 2-7 wherein a larger bound AN content than that of the range based on the present invention was used, soiling at the lip of the die and die streaks were occurred. In addition, in Experimental Example 2-8 wherein polybutadiene rubbery polymer was used, soiling at the lip of the die and die streaks were occurred, and whitening resistance was inferior.

On the other hand, Experimental Examples 2-1 and 2-2 had an excellent balance among categories for evaluation.

### 1-4. Preparation of Thermoplastic Resin and Evaluation for Blown Film Extrusion

Thermoplastic resins were prepared using the above-mentioned rubber-reinforced vinyl-based resins (A1) and the acrylonitrile·styrene copolymers (A2) and were subjected to blown film extrusion. Then various evaluations were performed.

### Experimental Example 3-1

First, the rubber-reinforced vinyl-based resin (A1-1) and the acrylonitrile-styrene copolymer (A2-1) were mixed using Henschel mixer in the proportions described in Table 4. The mixture was then charged into a twin-screw extruder and melt-kneaded at a temperature in the range from 200° C. to 240° C. to obtain pellets (thermoplastic resin). Graft ratio, intrinsic viscosity of a component dissolved by acetonitrile, bound acrylonitile content (bound AN content) and standard deviation of the distribution of the bound AN content for this resin were measured in the same manner mentioned above. These properties are shown in Table 4.

A film was manufactured by the method below using the above-mentioned pellets.

First, the pellets were fed into an extruder having a screw diameter of 50 mm and provided with an annular die having a diameter of 50 mm and a lip gap of 1.5 mm. The resin was discharged from the annular die at a melting temperature of 200° C., and an blown film bubble was formed at a processing rate of 10 m/min. The blow-up ratio (diameter of the blown film bubble/diameter of the die) at that time was as shown in Table 4.

The blown film bubble was cooled with an air ring to obtain a tubular film having a thickness shown in Table 4.

The above-mentioned melting temperature was measured using a thermocouple thermometer. As for the thickness of the film, after one hour had elapsed from initiation of the manufacture for the tubular film, one end of the film was cut away to a flat film, the thickness was measured at 10-mm intervals using a thickness gauge (Type “ID-C1112C” manufactured by Mitutoyo Corporation), and the average value was determined.

The evaluation categories were as follows, and the results are shown in Table 4.

### (1) Soiling of Lip of Die

The presence or absence of soiling (plate-out) on the lip of the die one hour after film manufacture commenced was visually evaluated.

### (2) Die Streaks

The presence or absence of die streaks on the outer surface of the tubular film one hour after film manufacture commenced was visually evaluated.

◯: Die streaks were not occurred.
Δ: Large amount of light die streaks were occurred.
X: Dense die streaks were occurred.

### (3) Wobble of the Blown Film Bubble

The presence or absence of wobble in the blown film bubble was visually evaluated in order to confirm whether the blown film bubble emerging from the annular die was stably formed.

### (4) Whitening Resistance

The resulting film was bent 180° at a temperature of 23° C. The bent portion was observed and evaluated based on the following criteria.

◯: Little whitening, being good.
X: Definite whitening, being inferior.

### Experimental Example 3-2

A film was manufactured an evaluated in the same manner as Experimental Example 3-1 except that the pellets of the rubber-reinforced vinyl-based resin (A1-2) was used. The results are listed in Table 4.

### Experimental Examples 3-3 to 3-8

Pellets were obtained in the same manner as Experimental Example 3-1, except that the types and proportions of the rubber-reinforced vinyl-based resins (A1) and the acrylonitrile-styrene copolymers (A2) described in Table 4 were used. After that, films were manufactured and evaluated in the same manner as Experimental Example 3-1. The results are listed in Table 4.

TABLE 4

| | | | | Experimental Example | | | | | | | |
|---|---|---|---|---|---|---|---|---|---|---|---|
| | | | | 3-1 | 3-2 | 3-3 | 3-4 | 3-5 | 3-6 | 3-7 | 3-8 |
| Thermoplastic | Formulation (parts) | Rubber-reinforced | A1-1 | 45 | | | | 45 | | | |
| resin | | vinyl-based resin | A1-2 | | 100 | | | | | | |
| | | (A1) | A1-3 | | | 45 | | | | | |
| | | | A1-11 | | | | 45 | | | | |
| | | | A1-12 | | | | | | 100 | | |
| | | | A1-13 | | | | | | | 100 | |
| | | | A1-14 | | | | | | | | 100 |
| | | Acrylonitrile-styrene | A2-1 | 55 | | 55 | 55 | | | | |
| | | copolymer (A2) | A2-2 | | | | | 55 | | | |

| | | | | | | | | | |
|---|---|---|---|---|---|---|---|---|---|
| Property | Graft ratio (%) | 85 | 120 | 85 | 100 | 85 | 85 | 90 | 125 |
| | Number-average particle diameter of | 110 | 110 | 50 | 330 | 110 | 120 | 120 | 115 |
| | acryl-based rubbery polymer (nm) | | | | | | | | |

| | | | | | | | | | |
|---|---|---|---|---|---|---|---|---|---|
| Component | Intrinsic | 0.45 | 0.55 | 0.45 | 0.52 | 0.45 | 0.45 | 0.55 | 0.55 |
| dissolved by | viscosity | | | | | | | | |
| acetonitrile | (dl/g) | | | | | | | | |
| | Bound | 24.0 | 24.5 | 24.0 | 24.1 | 28.5 | 14.5 | 40.5 | 24.5 |
| | AN content | | | | | | | | |
| | (%) | | | | | | | | |

| | | | | | | | | | |
|---|---|---|---|---|---|---|---|---|---|
| | Standard deviation σ of | 3.1 | 2.9 | 3.3 | 3.2 | 6.2 | 2.9 | 3.5 | 2.9 |
| | bound AN content | | | | | | | | |
| Evaluation in | Blow-up ratio | 2.0 | 1.6 | 2.0 | 1.6 | 1.6 | 2.0 | 1.6 | 2.0 |
| blown film | Film thickness (μm) | 80 | 100 | 80 | 100 | 100 | 80 | 100 | 80 |
| extrusion | Soiling at lip of the die | ◯ | ◯ | X | X | X | X | X | X |
| | Die streaks | ◯ | ◯ | ◯ | X | X | Δ | X | X |
| | Wobble of blown film bubble | ◯ | ◯ | X | X | X | X | X | X |
| | Whitening resistance | ◯ | ◯ | ◯ | X | ◯ | X | ◯ | X |

It is clear from Table 4. In Experimental Example 3-3, wobble of blown film bubble and dirty lip of the die were observed. Additionally, in Experimental Examples 3-4 to 3-8, blown film bubbles were distorted, and soilings at the lip of the die and die streaks were occurred. Experimental Examples 3-4, 3-6 and 3-8 were inferior in whitening resistance. On the other hand, Experimental Examples 3-1 and 3-2 had an excellent balance among categories for evaluation.

### Experimental Example 4-1

An anchor-coat composition prepared by using 280 parts of ion-exchanged water, 120 parts of isopropyl alcohol and 100 parts of an aqueous dispersion of a polyurethane resin having a solids concentration of 50% “Takelac XW-725-B-186C” (trade name) manufactured by Mitsui Takeda Chemicals, Inc. were subjected to application onto one surface of the film (50 mm×50 mm×100 μm) manufactured in Experimental Example 1-1 with a bar coater (#5). Drying was performed for 3 hours at a temperature of 800C. The thickness of the anchor coat formed was 1 μm Subsequently, a bar coater was used to apply the epoxy resin-based bonding agent “Cemedine 1500” (trade name) by CEMEDINE Co., ltd. so as to form a film having a thickness of approximately 10 μm on the surface of an synthetic wood plate (50 mm×50 mm×10 mm) obtained by extruding a composition containing wood flour and a resin.

After that, the surface of the anchor-coat layer of the film manufactured in Experimental Example 1-1 was then brought into contact with the surface of the synthetic wood plate on which the bonding agent had been coated, and the resulting assembly was let to stand at room temperature for one hour at a pressure of 10 kg/cm². A layered object was obtained.

Absolutely no whitening, wrinkling and delamination were visually observed on the surface of the film of the layered object.

### Experimental Example 4-2

A layered object was manufactured in the same manner as in Experimental Example 4-1, except that a buffed (#400) SUS304 plate (50 mm×50 mm×0.5 mm) was used instead of the above-mentioned synthetic wood plate.

Absolutely no whitening, wrinkling and delamination were visually observed on the surface of the film of the layered object.

### Experimental Example 4-3

A layered object was manufactured in the same manner as in Experimental Example 4-1, except that a plate (50 mm×50 mm×0.5 mm) composed of an ABS resin “TECHNO ABS600” (trade name) manufactured by Techno Polymer Co., Ltd. was used instead of the above-mentioned synthetic wood plate.

Absolutely no whitening, wrinkling and delamination were visually observed on the surface of the film of the layered object.

### INDUSTRIAL APPLICABILITY

The thermoplastic resin of the present invention is ideally used in an interior or exterior film for office articles including tapes (including tacky tapes), films (including tacky films, laminated films, masking films, and other films), and the like, stationary product such as pens and folders, household electrical goods such as refrigerators, washing machines, dryers, vacuum cleaners, electric fans, air conditioners, telephones, electric pots, rice cookers, dish-washing machines, dish-dryers, microwaves, mixers, televisions, video players, stereos, tape recorders, clocks, computers, displays and calculators, vehicle-related members, medical devices, optical devices, sports equipment, daily necessities, various containers and the like; a wallpaper; a decorative paper; a film for a substitute for a decorative paper; a floor material; and the like.

What is claimed is:

1. A thermoplastic resin characterized by comprising an acryl-based rubbery polymer reinforced resin having a graft ratio of 80% to 170%, a number-average particle diameter of an acryl-based rubbery polymer of 60 to 150 nm, an intrinsic viscosity of a component dissolved by acetonitrile of 0.4 to 0.8 dl/g, a content of a bound cyanidated vinyl compound in said component dissolved by acetonitrile of 20% to 30% by mass, and standard deviation of a distribution of said content of a bound cyanidated vinyl compound measured using liquid chromatography is 5 or less.

2. The thermoplastic resin according to claim 1,
wherein said acryl-based rubbery polymer reinforced resin comprises a graft copolymeric resin that is obtained by polymerizing a vinyl-based monomer containing an aromatic vinyl compound and a cyanidated vinyl compound in the presence of an acryl-based rubbery polymer.

3. The thermoplastic resin according to claim 2,
wherein said acryl-based rubbery polymer reinforced resin is one wherein a copolymer comprising a unit derived from an aromatic vinyl compound and a unit derived from a cyanidated vinyl compound is further incorporated.

4. The thermoplastic resin according to claim 1,
wherein said content of a bound cyanidated vinyl compound in said component dissolved by acetonitrile in said acryl-based rubbery polymer reinforced resin is in the range from 22% to 28% by mass.

5. The thermoplastic resin according to claim 1,
wherein said standard deviation of a distribution of said bound content of a cyanidated vinyl compound is 4 or less.

6. The thermoplastic resin according to claim 1,
wherein content of said acryl-based rubbery polymer is in the range from 5% to 50% by mass with respect to said thermoplastic resin.

7. The thermoplastic resin according to claim 1,
wherein a compound constituting said bound cyanidated vinyl compound is acrylonitrile.

8. The thermoplastic resin according to claim 1, which is used in extrusion molding.

9. The thermoplastic resin according to claim 8,
wherein said extrusion molding is at least one selected from the group consisting of calender molding, T-die molding and blown film extrusion.

10. A production method for said thermoplastic resin according to claim 1, characterized in comprising a polymerizing step for polymerization of a vinyl-based monomer containing an aromatic vinyl compound and a cyanidated vinyl compound while said vinyl-based monomer is added in the presence of an acryl-based rubbery polymer having a volume-average particle diameter of 60 to 150 nm,
wherein a ratio of a total amount of said aromatic vinyl compound and said cyanidated vinyl compound in said vinyl-based monomer is in the range from 70% to 100% by mass,
wherein amounts to be used of said aromatic vinyl compound and said vinyl cyanide compound are respectively from 70% to 80% by mass and from 20% to 30% by mass with respect to 100% by mass of the total of these compounds, and
wherein said polymerization is performed while polymerization conversion of said vinyl-based monomer in the reaction system is kept at 85% or more by mass.

11. A molded article characterized in comprising said thermoplastic resin according to claim 1.

12. The molded article according to claim 11,
wherein said molded article is a sheet or a film.

13. A composite article characterized in having a molded part comprising said thermoplastic resin according to claim 1, and a portion comprising at least one material selected from the group consisting of an organic material and an inorganic material, disposed on at least one part of a surface of said molded part.
